(19) United States
(12) Patent Application Publication
(10) Pub. No.: US 2004/0128914 A1
(43) Pub. Date: Jul. 8, 2004

(54) Window or door structure

(76) Inventor: Willi Hempelmann, Olpe (DE)

Correspondence Address: BIRCH STEWART KOLASCH & BIRCH, PO BOX 747, FALLS CHURCH, VA, 22040-0747, US

(21) Appl. No.: 10/471,920

(22) PCT Filed: Mar. 21, 2002
(86) PCT No.: PCT/EP02/03188

(30) Foreign Application Priority Data
Mar. 21, 2001 (DE) 101137842

(51) Int. Cl. E05F 11/52

(52) U.S. Cl. 49/192; 49/246; 49/149

(57) ABSTRACT

In a window or door construction, comprising a frame, a casement/leaf attached moveably to the frame and mounting modules between the frame and casement/leaf, to control the casement/leaf an encircling control element is provided which can be driven by a motor and a handle module, is in engagement, in the various positions of the casement/leaf relative to the frame, with at least one mounting module and controls the sequence of movement of the mounting modules in such a manner that a clear sequence of the casement/leaf movements is ensured by the sequential succession of the control movements of the control element and of a slide, which is driven by the motor and can be connected to the control element.

The invention relates to a window or door construction having a frame and a casement/leaf attached moveably to the frame.

The invention is based on the object of designing a window or door construction of this type in such a manner that a motor-operated actuation can be realized in a simple manner.

This object is achieved according to the invention by the features of claim 1. The provision of an encircling control element which controls the sequence of movement of the mounting modules provided between the frame and casement/leaf makes it possible for a single motor to drive this control element in such a manner that the opening and closing movements of the casement/leaf are executed, the motor drive also giving rise to the possibility of remote control.

Embodiments by way of example will be explained in greater detail below with reference to the drawings, in which:

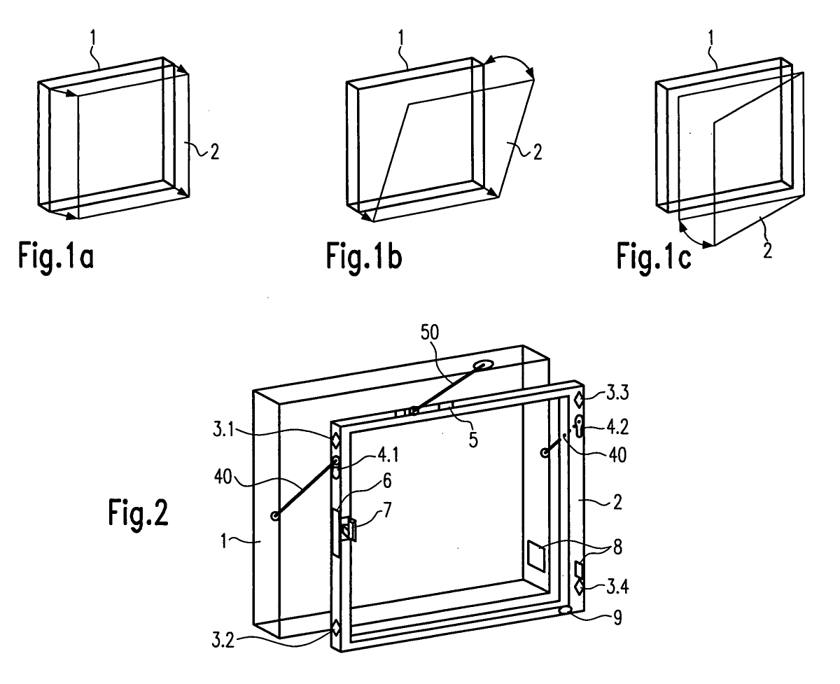

FIG. 1 shows, in schematic views, the types of opening of the casement of a window,

FIG. 2 shows, schematically, the arrangement of various mounting modules on the circumference of the window construction,

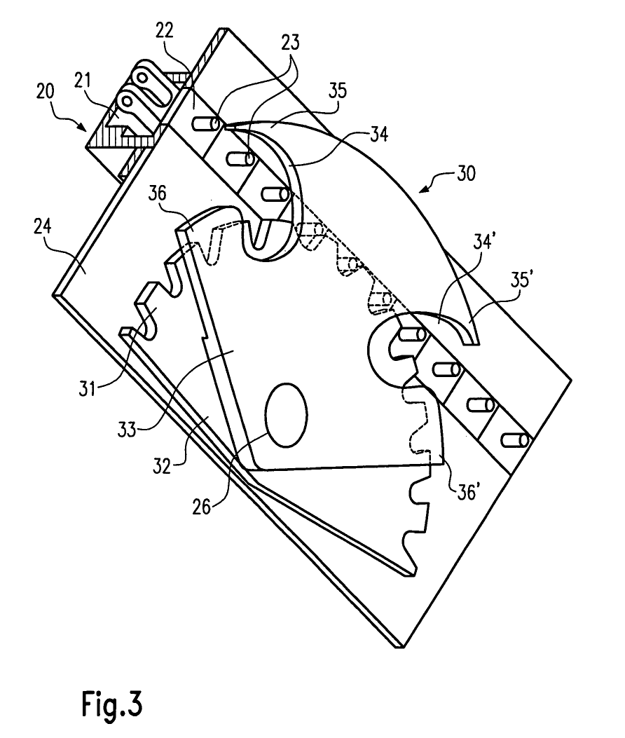

FIG. 3 shows, in a perspective illustration, a mounting module,

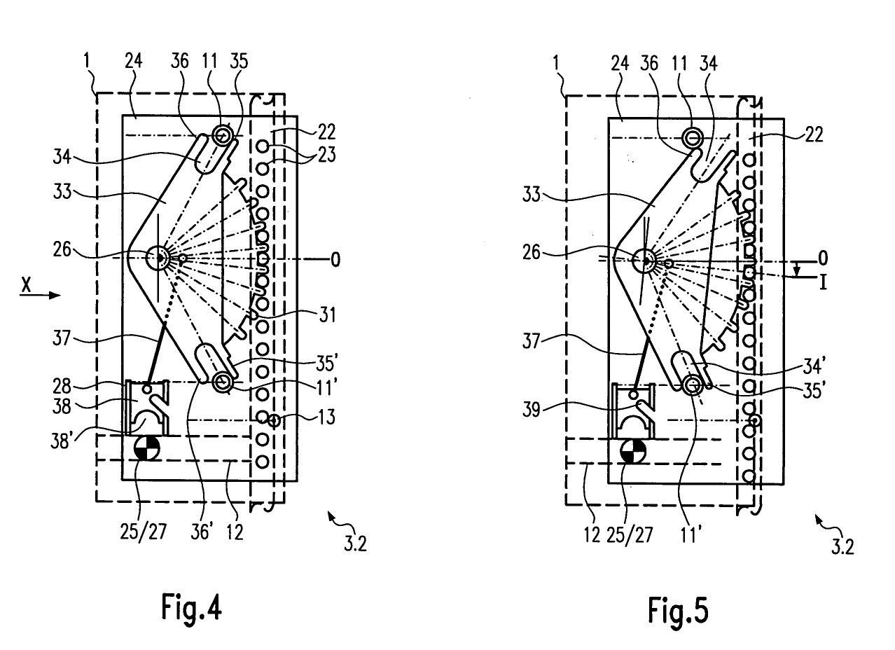

FIGS. 4-7 show, in a schematic illustration, different positions of the mounting module according to FIG. 3,

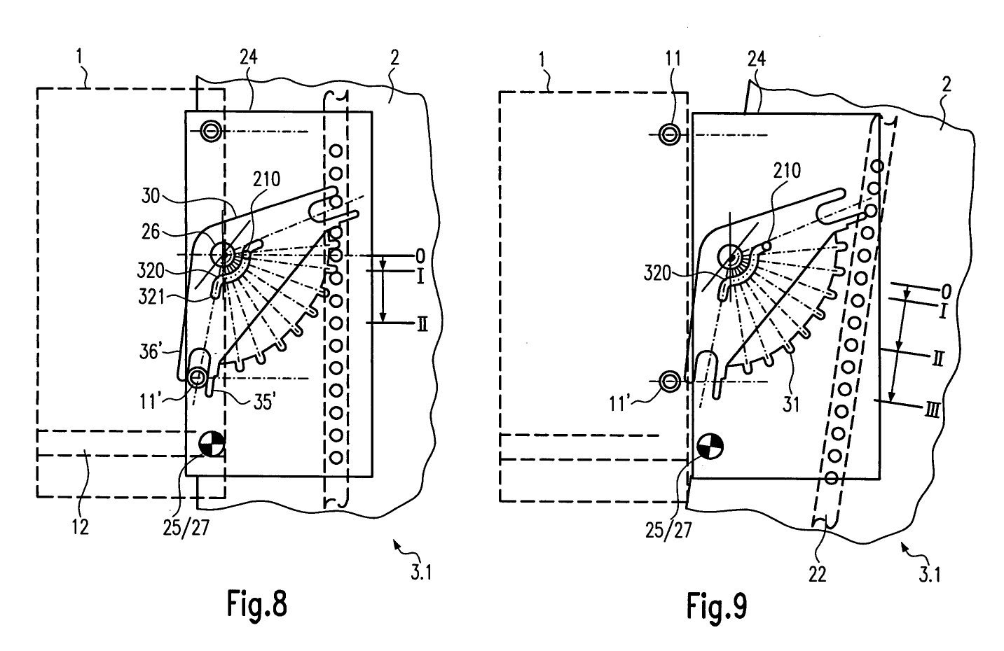

FIGS. 8+9 show a schematic view of two operating positions of a different mounting module,

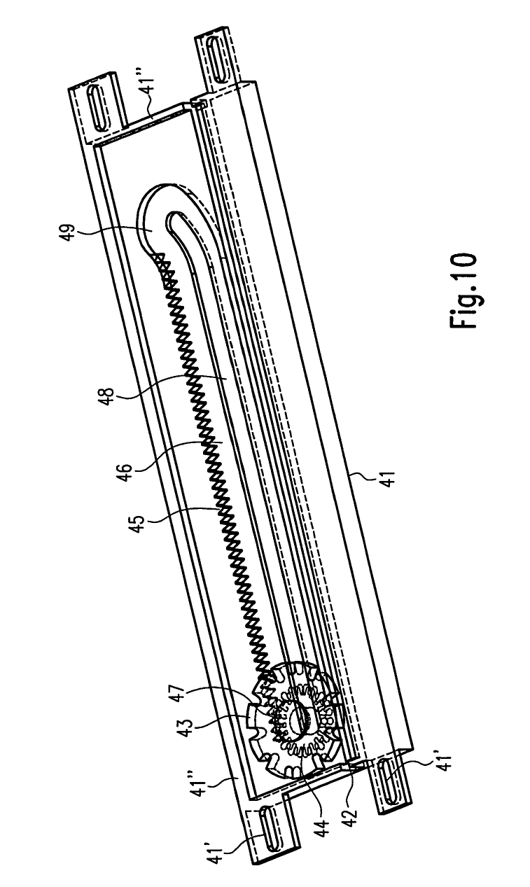

FIG. 10 shows, in a perspective view, part of a tilting lever module,

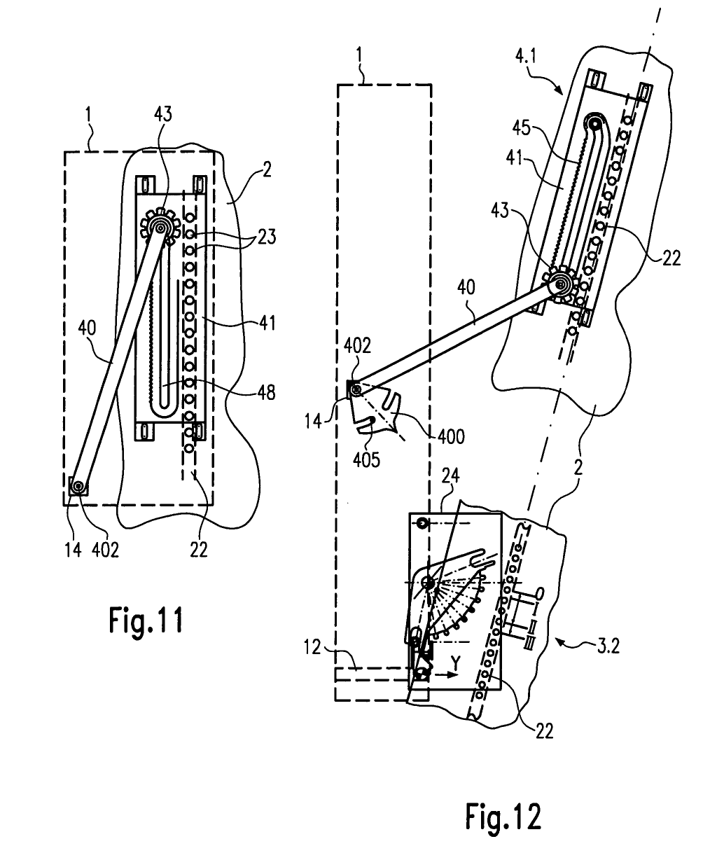

FIG. 11 shows a view of the tilting lever module according to FIG. 10 with the tilting lever,

FIG. 12 shows the tilting lever module in the tilting position with the mounting module,

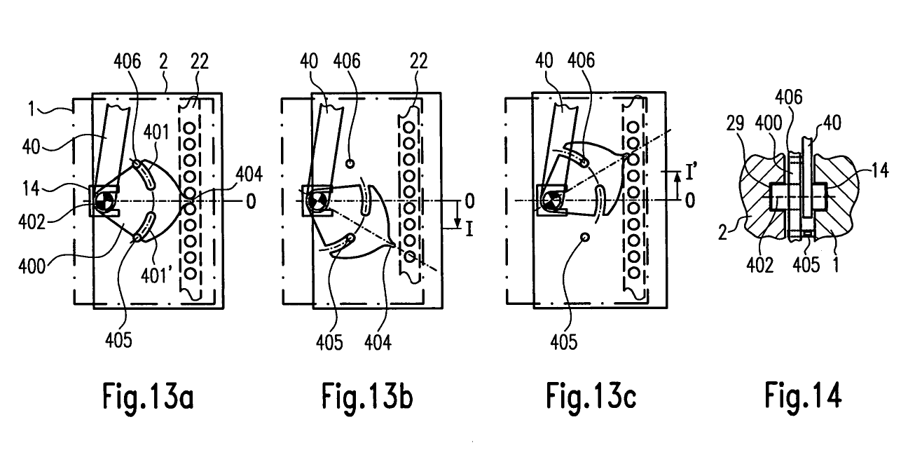

FIG. 13 shows a component of the tilting lever module in various operating positions,

FIG. 14 shows a sectional view of the articulation region of the tilting lever in FIG. 13,

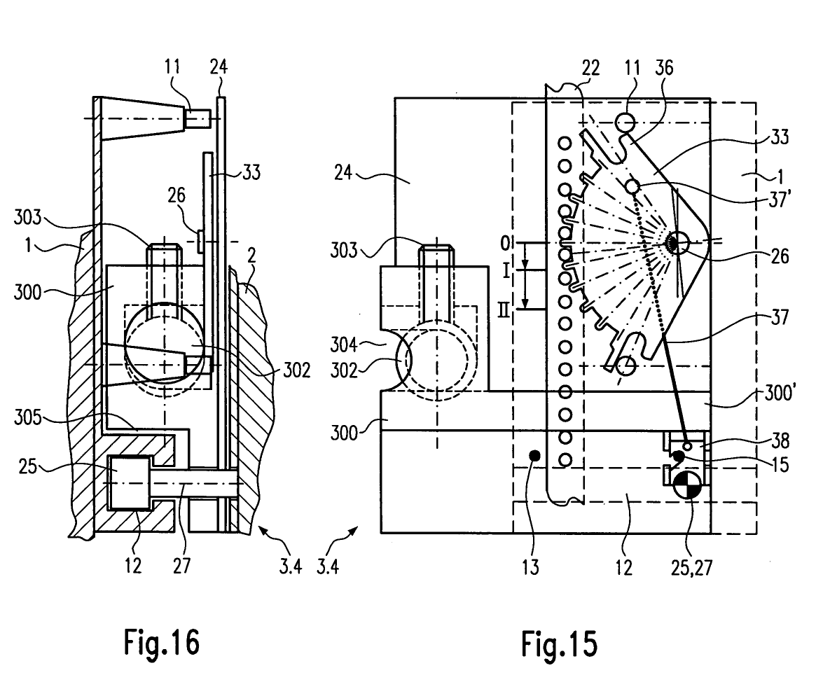

FIG. 15 shows a view of the mounting module with a pivoting function,

FIG. 16 shows a view of the mounting module from the left in FIG. 15,

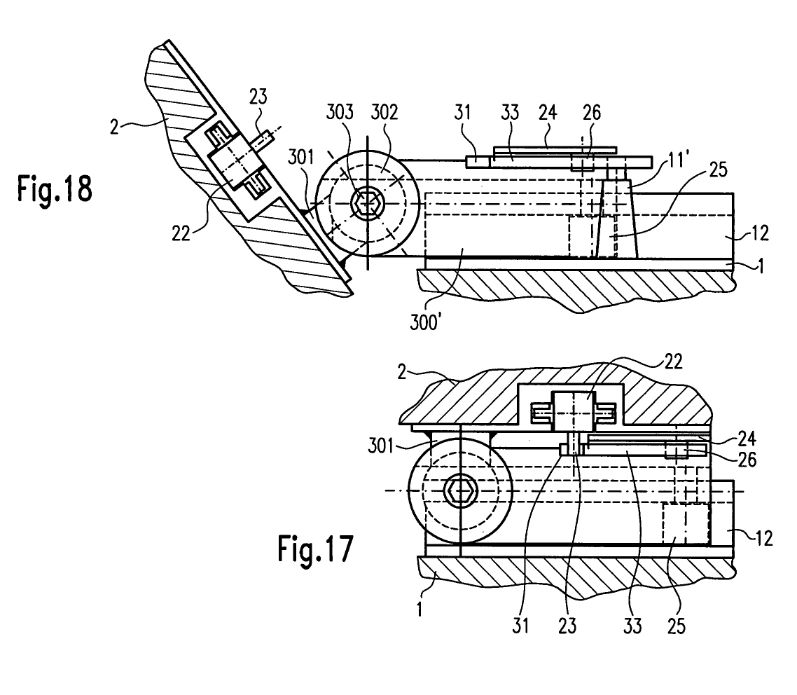

FIG. 17 shows a view of the mounting module from below in FIG. 15,

FIG. 18 shows a pivoting position of the mounting module,

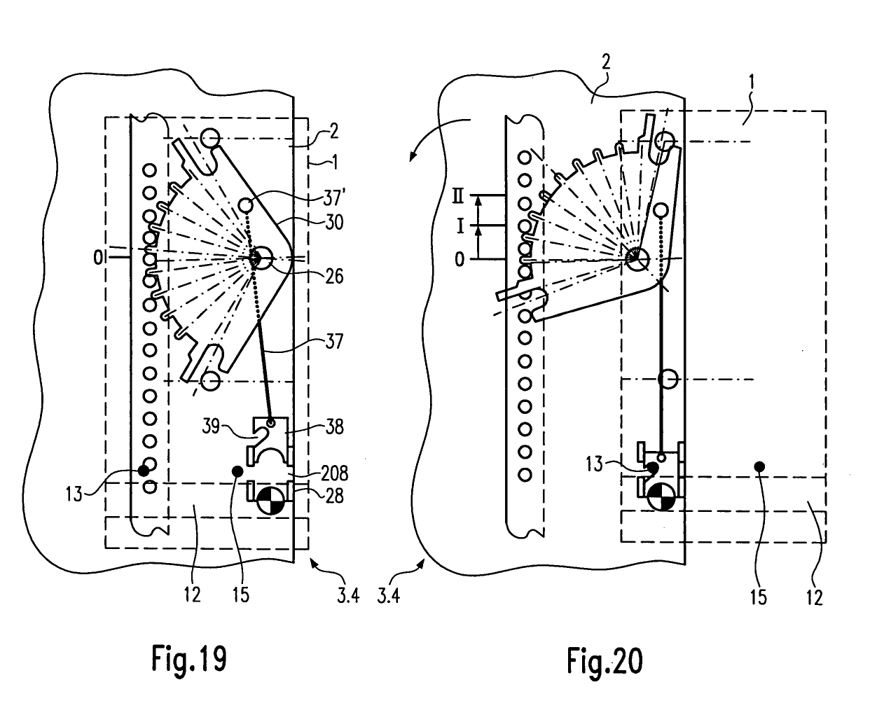

FIGS. 19+20 shows schematic views of two operating positions of a mounting module,

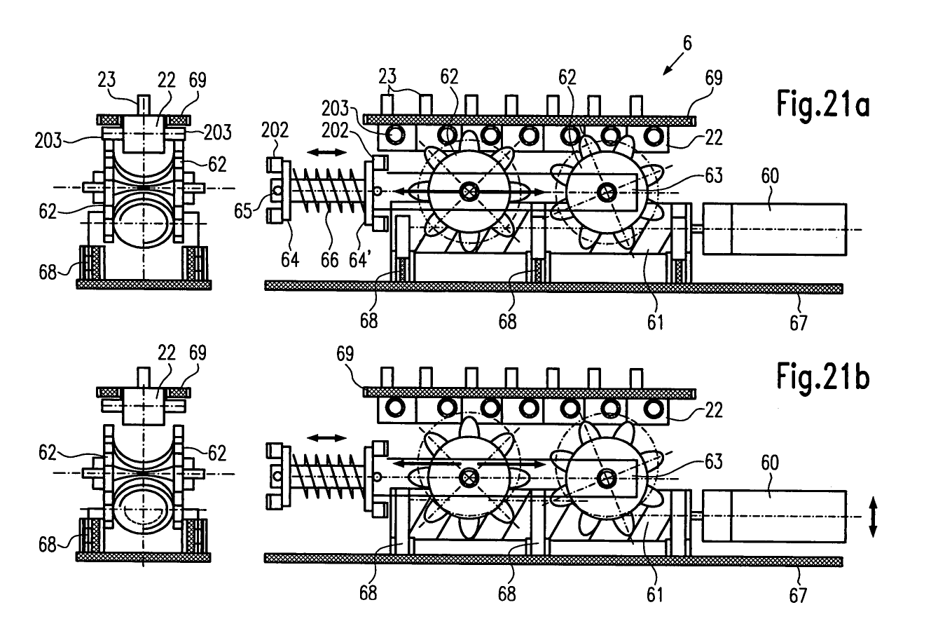

FIG. 21 shows schematic views of a driving module in two operating positions,

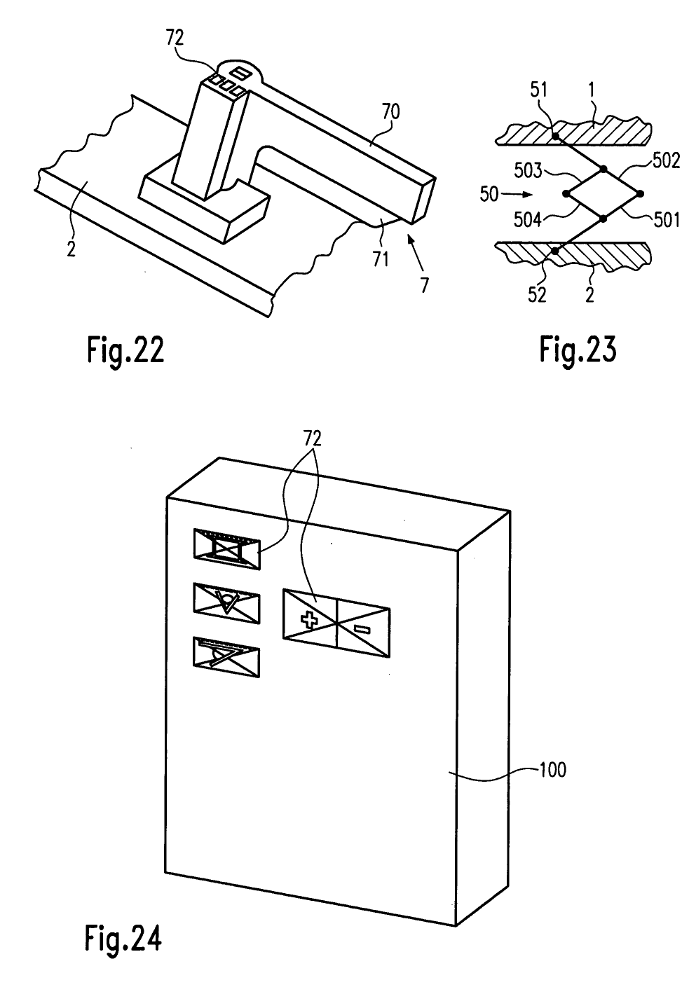

FIG. 22 shows a perspective view of a handle module,

FIG. 23 shows a schematic view of a pivoting lever,

FIG. 24 shows a schematic view of the keyboard on a remote control unit,

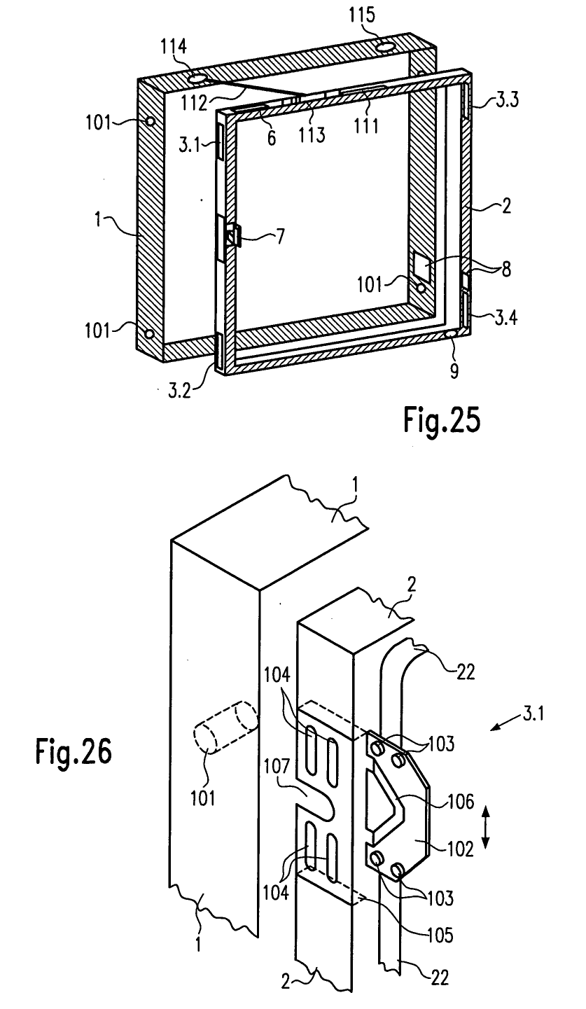

FIG. 25 shows, schematically, the arrangement of the mounting modules in a second embodiment of the invention,

FIG. 26 shows, in an exploded view, the construction of a mounting module,

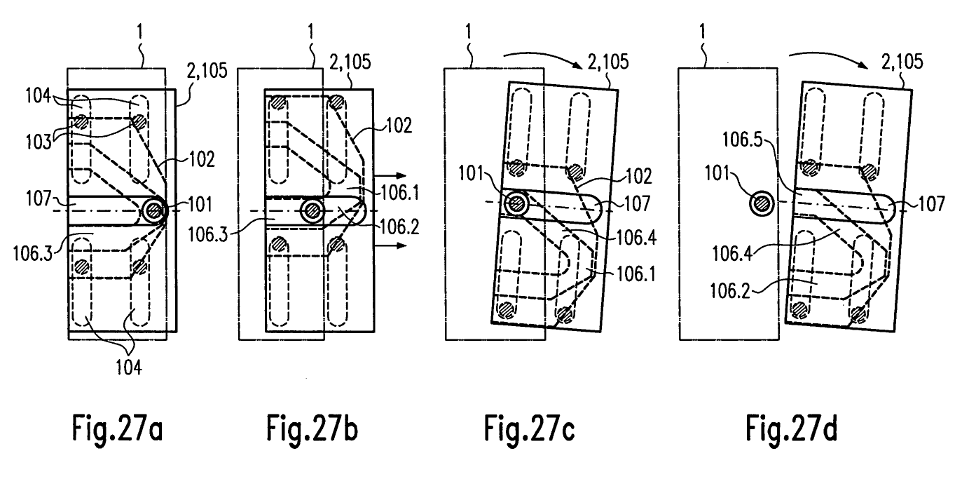

FIG. 27 shows, in a schematic illustration, various positions of the mounting module according to FIG. 26,

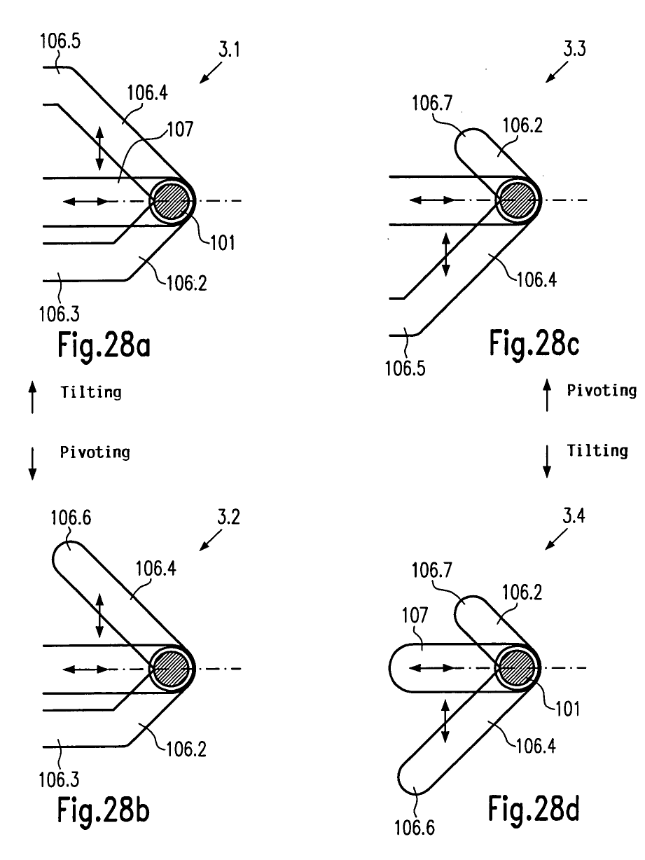

FIG. 28 shows the design of the control groove on the four mounting modules in the second embodiment,

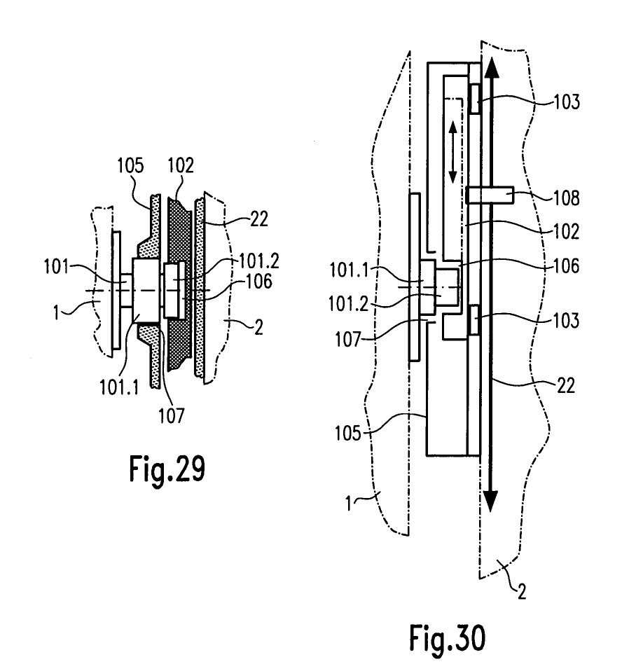

FIG. 29 shows, schematically, a sectional view of a mounting module,

FIG. 30 shows the construction of a mounting module according to FIG. 26, schematically in a longitudinal section,

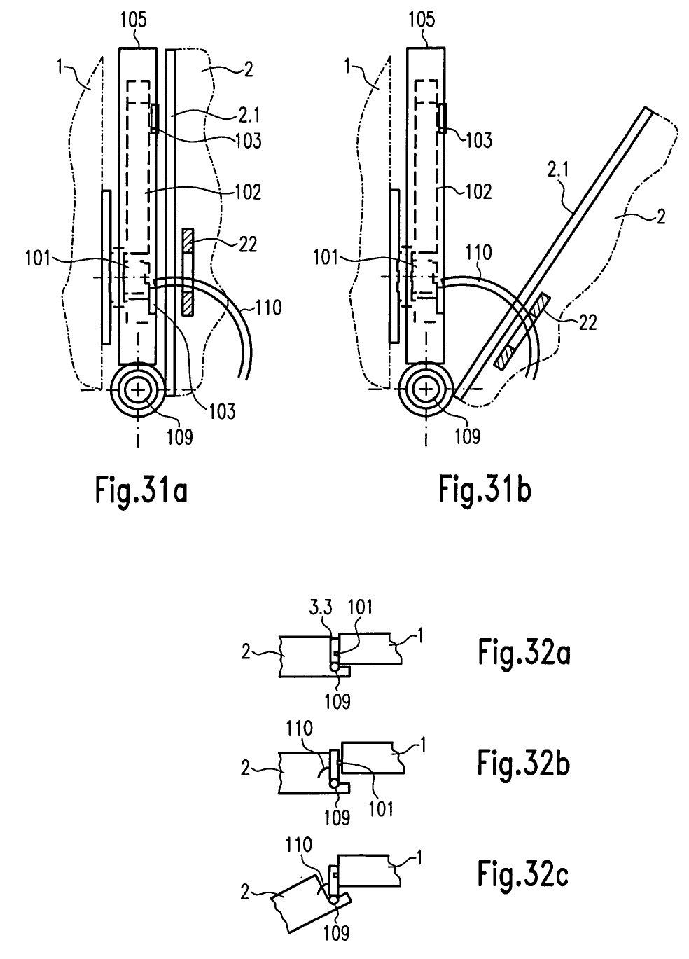

FIG. 31 shows two positions of a mounting module with a hinge,

FIG. 32 shows, schematically, various positions between the frame and casement/leaf according to the second embodiment,

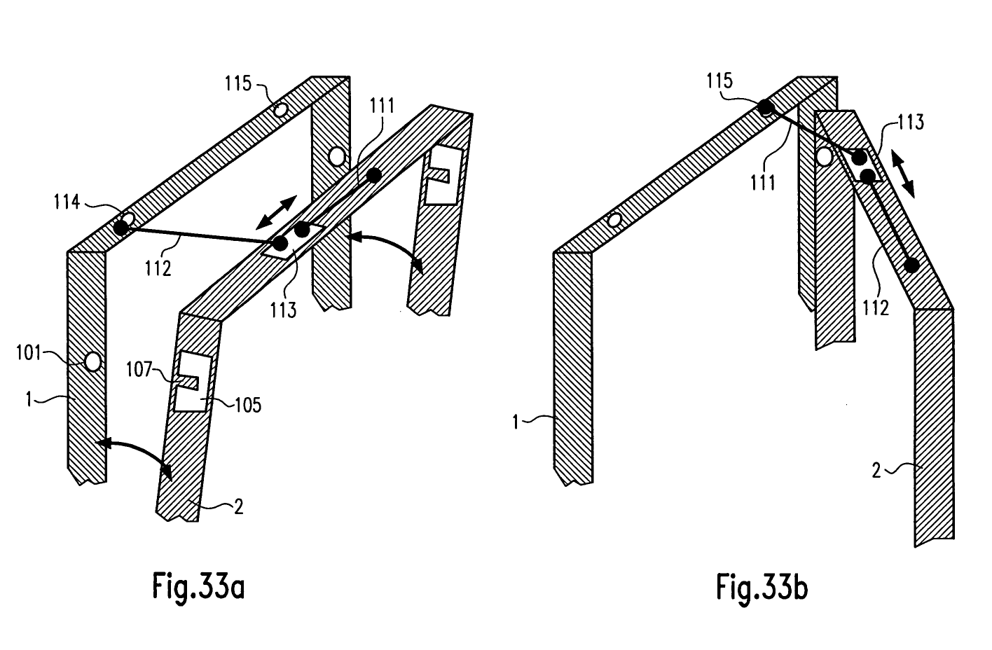

FIG. 33 shows, schematically, the construction of the pivoting and tilting lever module according to the second embodiment,

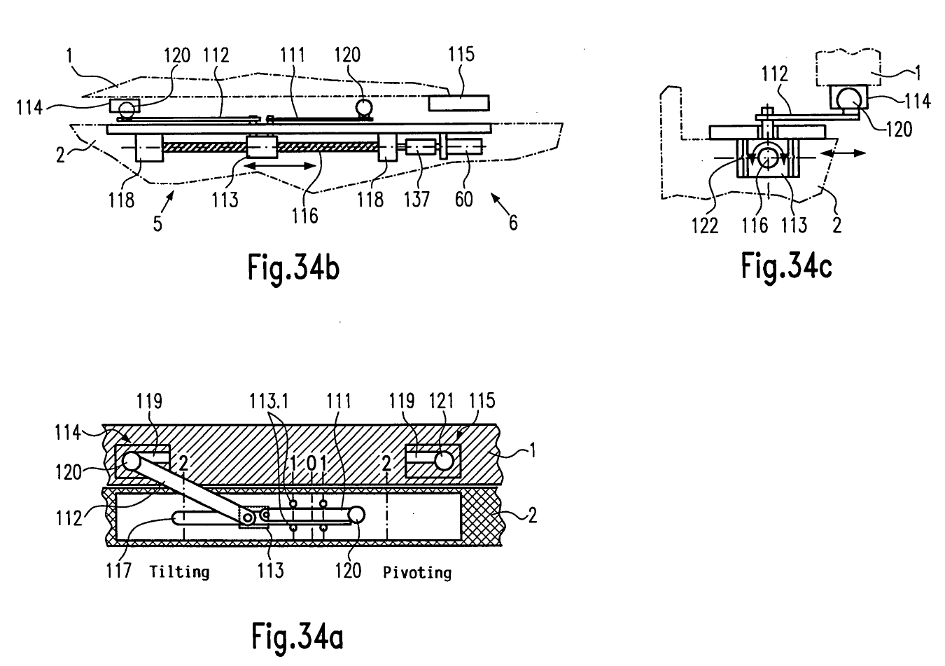

FIG. 34 shows the design of the pivoting and tilting lever module according to FIG. 33,

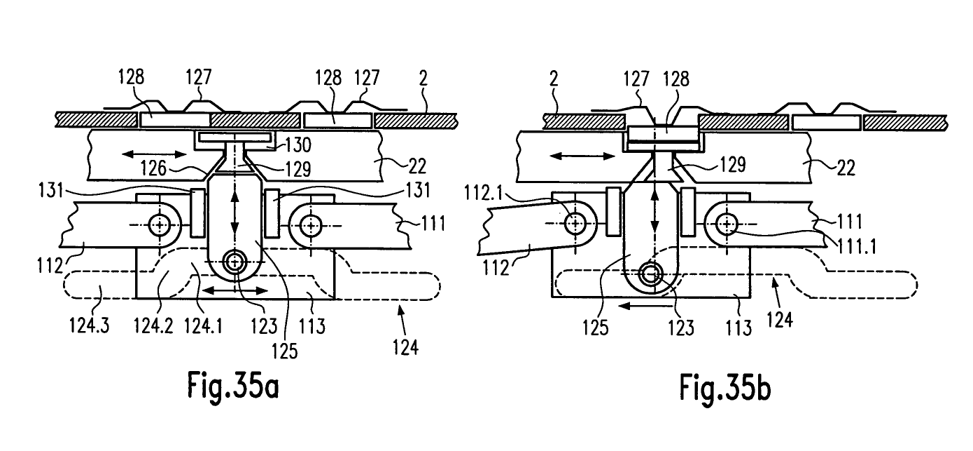

FIG. 35 shows the coupling mechanism between the control element and slide on the pivoting and tilting lever module according to FIGS. 33 and 34,

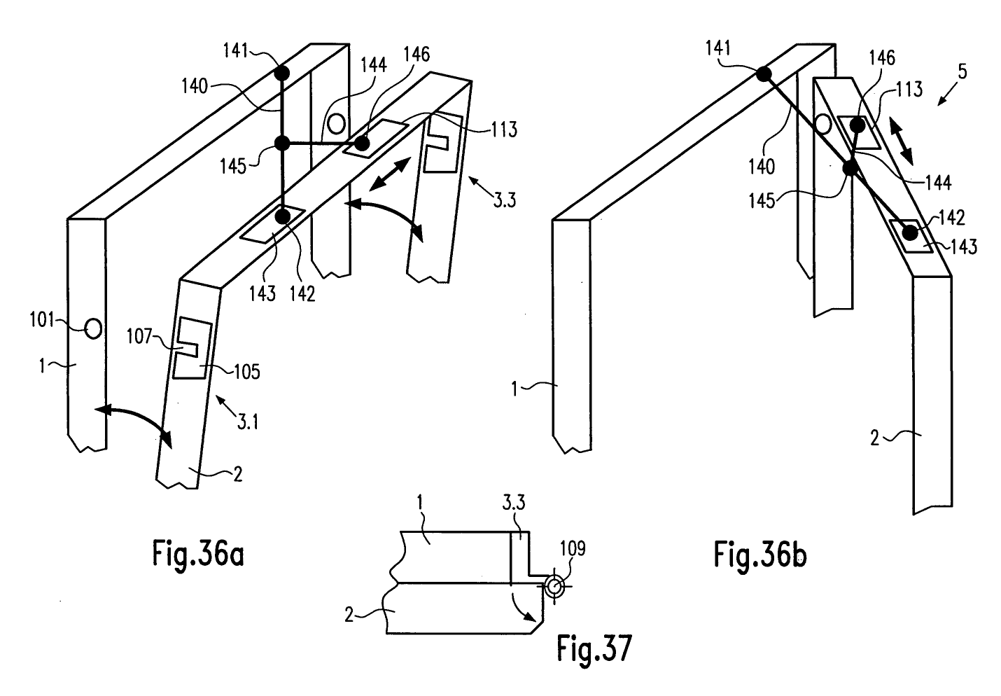

FIG. 36 shows a third embodiment of a pivoting and tilting lever module, and

FIG. 37 shows the arrangement of the hinge between the frame and casement/leaf when the pivoting and tilting lever module according to FIG. 36 is used.

FIG. 1 shows, schematically, the stationary frame 1 of a window and a casement 2 attached moveably thereto, in which

FIG. 1a reproduces a parallel lifting-off of the casement 2 from the frame 1, for example for ventilation purposes.

FIG. 1b shows the tilting of the window casement 2 following the parallel lifting-off according to FIG. 1a, and

FIG. 1c shows the pivoting of the window casement 2 after the casement has been lifted off parallel by a certain amount from the frame 1.

FIG. 2 shows, in a first embodiment according to FIGS. 2 to 21, various mounting modules in the circumference of the window construction, the mounting modules being preferably attached to the casement 2 together with a control element 22. Two mounting modules 3.1, 3.2 and 3.3, 3.4 for the parallel lifting-off of the casement 2 from the frame 1, the function of which modules will be explained below, are provided in each case on both sides of the casement 2, in the vicinity of the corners of the casement.

For tilting of the casement 2, a tilting lever module 4.1 and 4.2 is attached to the casement 2 in the upper region on both sides, the said modules interacting with the two lower mounting modules 3.2 and 3.4 for the parallel lifting-off in order to tilt the casement 2.

To pivot the window casement 2, a pivoting lever module 5 is provided on the upper side of the said casement and interacts with the two mounting modules 3.3 and 3.4 on the side of the casement 2 which is on the right in FIG. 2.

In the profile of the casement 2, a driving module 6 is furthermore accommodated in the region of a handle module 7 which, in addition to the customary function of a window handle, executes further control functions, as will be described in greater detail below.

The arrangement of a supply module by means of which the driving module 6 is supplied with current is indicated at 8.

Furthermore, a sensor module 9 which establishes the individual functions and positions of the casement relative to the frame 1 and passes on corresponding information, for example to a central monitoring and control point, can be fixed on the casement 2.

FIG. 3 shows a perspective view of the basic construction of a mounting module 3.1 to 3.4 which, among other things, controls the parallel lifting-off of the casement 2 from the window 1. At 20, a section of a window casement profile is reproduced, the said section being provided with a circumferential groove 21 and being able to have a cross-sectional design which is known per se and is not reproduced more specifically. A control element in the form of a link chain 22 is guided in the groove 21, which encircles the circumference of the casement 2, and has, on the individual chain links, control pins 23 which protrude on the circumference parallel to the plane of the window. A plate 24, on which a sector element 30 is mounted pivotably via a rotary pin 26 on the side which faces the frame 1 in FIG. 2, is attached to the casement profile 20. The chain 22 provided with the control pins 23 extends along one edge of the plate 24.

This sector element 30 has a semicircular toothed ring 31 on the circumference of a semicircular disc 32, which toothed ring is in engagement with the control pins 23 of the chain 22 in the illustration according to FIG. 3. A retaining element 33, which is in the shape of a sector of a circle, protrudes over the control pins 23 and is not in engagement therewith, is connected fixedly to the semicircular disc 32. Recesses 34 and 34′, which are designed to receive a retaining pin 11 (FIGS. 4 to 7), are formed on both sides of the retaining element 33 at an angular distance from the rotary pin 26. On the side which is remote from the rotary pin 26 or on the radially outer side, the two recesses 34 are covered by extensions 35 and 35′ of the retaining element 33 while, on the inner side, the recesses 34 merge into a shoulder 36 and 36′. In the exemplary embodiment according to FIG. 3, this section of the retaining element 33 which is provided with the recesses 34 is arranged at a distance above the toothed ring 31 and the control pins 23 by a shoulder being formed or a spacer disc being arranged between the semicircular disc 32 and the retaining element 33.

The sector element 30 having the plate 24 is present in all of the mounting modules 3.1 to 3.4, this sector element being reproduced schematically in the following figures to clarify the control functions, and the toothed ring 31 protruding over the retaining element 33 in the radial direction.

Closed Position of the Window

FIG. 4 shows, for example, the mounting module 3.2 to explain the retaining function of the casement 2 on the frame 1, which is indicated by dashed lines in FIG. 4. Two retaining pins 11 and 11′ are attached to the frame 1 at a distance in the circumferential direction and interact with the two recesses 34 and 34′ of the retaining element 33 on the casement 2, as follows.

In the closed position of the window according to FIG. 4, the two retaining pins 11 and 11′, which are fastened to the frame 1, bear against the shoulders 36 and 36′ on both sides of the retaining element 33, so that a wind force acting in the direction of the arrow X in FIG. 4 cannot lift off the casement 2 from the frame 1 because the retaining element 33 is connected fixedly to the casement profile 20 and to the casement 2 via the rotary pin 26.

A horizontally extending guide groove 12 is formed on the frame 1 in the region of each of the four mounting modules 3.1 to 3.4 and in it is guided a roller 25 which, in the view according to FIG. 4, is arranged in the region of the left, lower corner of the plate 24 of the mounting module and is fastened to the casement 2 via a shank 27, the shank 27 protruding through a hole in the plate 24 (cf. FIG. 16). The load of the casement 2 is supported on the frame 1 via these four rollers 25 on the mounting modules 3.1 to 3.4.

Parallel Lifting-Off of the Casement from the Frame

In order for it to be possible for the window to be opened from the closed position in FIG. 4, a preliminary control movement of the chain 22 upwards or downwards from the initial position, which is referred to by 0 in FIG. 4, takes place, so that the retaining element 33 is pivoted somewhat by the chain 22 and comes free from one of the two retaining pins 11 or 11′.

FIG. 5 shows this preliminary control movement, in which the chain 22 is moved downwards in FIG. 5 from the position 0 into the position I in order to pivot the retaining element 33 via the toothed ring 31 in the clockwise direction about the rotary pin 26 until the shoulder 36 on the upper recess 34 of the retaining element 33 is released from the engagement with the upper retaining pin 11. In FIG. 5, this is illustrated in simplified form by a shortening of the shoulder 36 on the retaining element 33. In the exemplary embodiment of the retaining element according to FIG. 3, the transition between the groove section of the recess 34 and the shoulder 36 is designed in such a manner that, during the pivoting movement of the retaining element 33 caused by the preliminary control movement of the chain, the upper pin 11 slides along this transition and comes free from the shoulder 36.

At the same time as this pivoting movement of the retaining element 33, the lower retaining pin 11′ comes to bear against the extension 35′ on the recess 34′. After release of the engagement between the upper retaining pin 11 and recess 34, a lift-off movement of the casement from the frame can be executed to the right in FIG. 5 because the retaining element 33 is no longer supported on the two retaining pins 11 and 11′.

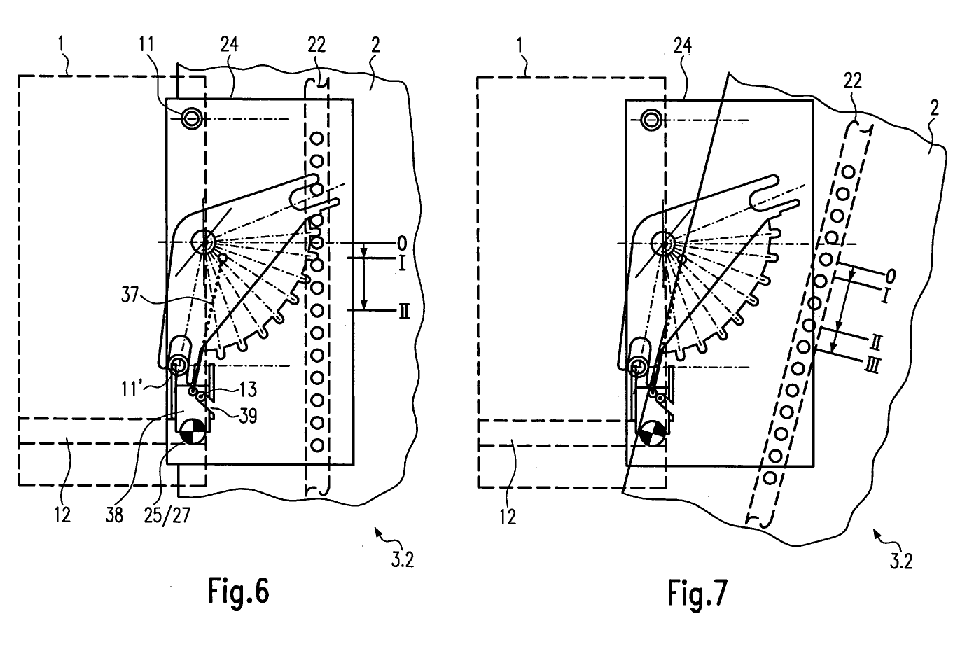

FIG. 6 shows the position of the mounting module 3.2 after a further control movement of the chain 22 downwards over the section I and II, in which case the retaining element 33 has executed a pivoting movement in the clockwise direction over approximately 30° about the rotary pin 26. The upper end of the retaining element 33 has come away from the upper retaining pin 11 of the frame 1 while the lower retaining pin 11′ is, as before, in engagement with the recess 34′ of the retaining element.

The adjusting movement of the chain 22 from the position I in FIG. 5 into the position II in FIG. 6, the retaining element 33 is pivoted in the clockwise direction, the lower extension 35′ of the retaining element being pressed against the lower retaining pin 11′, so that the casement 2 is lifted off from the frame 1 owing to the lever (chain-dotted line) between the lower retaining pin 11′ and the rotary pin 26. In this case, the roller 25, which is fastened to the casement 2, is supported in the horizontal guide 12 of the frame 1. This control process takes place synchronously at the four mounting modules 3.1 to 3.4 by means of the encircling chain 22, with the result that the casement 2 is lifted off parallel from the frame 1.

FIG. 6 shows the position of the casement 2 in which it is lifted off to the maximum from the frame 1, in which case the roller 25 is supported at the right end of the horizontal guide 12 of the frame 1 and the frame thereby absorbs the weight of the lifted-off casement 2.

During the parallel lifting-off of the casement 2 from the frame 1 (FIG. 1a), any desired intermediate position between the casement and frame can be taken up, depending in each case on the controlling displacement of the chain 22 from the position I in the direction of position II, in order, for example, to enable a constricted ventilation of a room by means of a casement which is only slightly lifted off from the frame.

During the closing movement from the parallel position in FIG. 6 or from an intermediate position back into the position according to FIG. 4, the chain 22 is initially moved back out of the position II or an intermediate position into the position I according to FIG. 5, in which case the retaining element 33 is pivoted in the anticlockwise direction via the toothed ring 31. In this case, the lower shoulder 36′ presses against the lower retaining pin 11′, as a result of which the casement 2 is pushed in the direction of the frame 1 via the lever between the rotary pin 26 and retaining pin 11′, and the roller 25 is displaced into the left in the figures in the horizontal guide 12 of the frame 1. When the position according to FIG. 5 is reached, the chain 22 is moved back by the preliminary control amount from the position I into the position 0, in which case the casement 2 is pressed against the frame 1 via the lower shoulder 36′ of the retaining element 33 which is supported on the lower retaining pin 11′, while the upper retaining pin 11 comes to lie in the recess 34 of the retaining element in such a manner that the upper shoulder 36 is supported on the retaining pin 11 in the same position as the lower shoulder 36′. In this closing movement, in which the casement 2 comes to bear tightly against the frame 1, an elastic seal provided between the frame 1 and casement 2 is compressed, the prestressing of the seal ensuring that the two retaining pins 11 and 11′ bear against the shoulders 36 and 36′ of the retaining element 33, and therefore ensuring a tight closed position of the window.

To initiate the lift-off movement of the casement 2 from the frame 1, the control chain 22 can be moved upwards or downwards from the position 0 by the amount of the preliminary control movement from 0 to I, so that the retaining element 33 comes free from one of the two retaining pins 11 or 11′. In the exemplary embodiment according to FIG. 5, the chain 22 has been moved into a preselection position for tilting of the window from the position 0 downwards into the position I.

Tilting of the Window

From the position of maximum parallel lifting-off according to FIG. 6, a tilting movement of the casement can take place, as FIGS. 7 and 10 show, the roller 25 on the two lower mounting modules 3.2 and 3.4 being fixed in its supporting position in the horizontal guide 12 and the plate 24 of the mounting module being held vertically while the casement 2 is pivoted relative to the plate 24.

The plate 24 having the sector element 30 (FIG. 3) is mounted pivotably on the profile of the casement 2 by the roller 25 being fastened via the shank 27 to the profile of the casement 2 (FIG. 14), the shank 27 being guided through a hole in the plate 24 and carrying the roller 25 rotatably at the free end. The plate 24 having the retaining element 33 can therefore be pivoted about the shank 27 of the roller 25 relative to the casement 2, as FIG. 7 shows.

A pin 13 which protrudes parallel to the roller 25 is fastened to the frame 1 above the horizontal guide 12, at the right end thereof, as indicated schematically in FIGS. 4 and 5. This pin 13 is used for holding the plate 24 in the vertical position relative to the tilted casement 2 (FIG. 7), as will be explained below.

In the position of FIG. 4, a link 37 is articulated on the semicircular disc 32 and on the retaining element 33 approximately horizontally next to the rotary pin 26 and a supporting element 38 is articulated on its opposite end, the supporting element being guided in a vertical guide 28 on the plate 24 and having an approximately semicircular recess 38′ for fitting over the shank 27 of the roller 25.

During the pivoting movement of the retaining element 33 in the clockwise direction from the position in FIG. 4 into the position according to FIG. 6, this supporting element 38 is displaced downwards on the plate 24 via the link 37, so that it comes to rest on the shank 27 towards the end of the lift-off movement of the casement, as FIG. 6 shows. During the horizontal displacement of the plate 24 relative to the frame 1 from the position in FIG. 4 into the position in FIG. 6, the supporting element 38, shortly before reaching the position in FIG. 6, comes into engagement with the pin 13, which is fastened to the frame 1, the supporting element 38 containing an oblique groove 39 in which the pin 13 engages while the supporting element 38 is placed on the shank 27 of the roller 25. This placing on the shank 27 of the roller 25 and the latching of the pin 13 in the groove 39 take place in the end region of the movement of the control chain 22 into the position II.

During the movement of the control chain 22 into the position II in FIG. 6, the tilting lever modules 4.1 and 4.2 have already been activated and brought into engagement with the control chain, as a result of which, during the further control movement of the chain 22 from the position II into the position III (FIG. 7), the upper part of the casement 2 is guided away from the frame via the tilting lever 40 of the tilting modules (FIGS. 9 and 10), so that the lower part of the casement 2 pivots about the shank 27 into the position of FIGS. 7 and 10 while the plate 24 is held in the vertical position via the pin 13, so that the chain 22 can be released from engagement with the toothed ring 31 of the retaining element 33.

In the tilting position according to FIG. 7, the rollers 25 on the two lower mounting modules 3.1 and 3.4 lie in the horizontal guide 12 of the frame 1, which is at a predetermined distance from the lower corner of the casement 2, while the rollers 25 on the upper mounting modules 3.1 and 3.3 are released from the frame and the tilting lever modules 4.1 and 4.2 have taken over the securing and guiding of the upper part of the casement 2. In the tilting position according to FIGS. 7 and 10, the plate 24 of the two upper mounting modules 3.1 and 3.3 is likewise held vertically relative to the tilted casement 2, so that, under the same conditions and in the same relative positions of the components, the chain can also be lifted off from the toothed ring 31 at the upper mounting modules 3.1 and 3.3, after which the entire upper mounting modules 3.1 and 3.3 are also lifted off from the frame 1.

FIGS. 8 and 9 show the mounting modules 3.1, which is attached to the casement 2 via the mounting module 3.2 of FIGS. 4 to 7, in which FIG. 8 corresponds to the position in FIG. 6, and FIG. 9 shows the lifting-off of the mounting module from the frame 1 as the tilting movement of the casement 2 begins and before the complete tilting position of FIG. 7 is reached.

Since it is not necessary for the roller 25 to be fixed at the upper mounting modules 3.1 and 3.3 to the frame 1 during the tilting movement, the supporting element 38 of FIGS. 4 to 7, which is guided in the guide 28 on the plate 24, is omitted in the mounting module 3.1. In order for the plate 24 nevertheless to be held during the tilting movement of the casement 2, a radial cam 320 is formed on the sector element 30 around the rotary pin 26 and a pin 210, which is fastened to the casement 2, engages in it. The radial cam 320 is formed on a radius around the rotary pin 26 and has radially outwardly bent ends 321. Owing to the same mounting module being used on both sides of the casement, the radial cam 320 is formed symmetrically with respect to the central line of the sector element 30, the pin 210, in the initial position of the mounting module 3.1 corresponding to FIG. 4, lying on the central line of the sector element 30, which corresponds to the centre of the radial cam 320. In the position of FIG. 8, the sector element 30 is pivoted by means of the control movement of the chain 22 into the position II in the clockwise direction until the pin 210, which is secured to the casement 2, comes to lie in the vicinity of the upper end 321 of the radial cam 320. The further control movement of the chain 22 in the direction of the position III causes the sector element 30 to be pivoted further out of the position of FIG. 8, in which case first of all the lower extension 35′ disengages from the lower retaining pin 11′ of the frame 1 and the lower shoulder 36′ comes free from the retaining pin 11′. At the same time, the tilting lever modules 4.1 and 4.2 initiate the tilting movement of the casement 2, in which the entire mounting module 3.1 is released from the frame 1, as FIG. 9 shows. During this control movement of the chain 22 from the position II in the direction of the position III, the pin 210, which is fastened to the casement 2, comes to lie in the upper, bent end 321 of the radial cam 320, as FIG. 9 shows. Until this position of the pin 210 is reached, the chain 22 is still in engagement with the toothed ring 31, so that the plate 24 is held in the vertical position. In the position of FIG. 9, the chain 22 is released from engagement with the toothed ring 31, further pivoting of the plate 24 being prevented by the pin 210 bearing against the end of the radial cam 320. Until the maximum tilting position according to FIG. 7 and FIG. 12 is reached, the plate 24 maintains the relative position to the casement 2, which is reproduced in FIG. 9 and in which the plate 24 is not pivoted relative to the casement 2 to such an extent as in FIG. 7, this reduced pivoting position of FIG. 9 being sufficient, however, in order, when the casement 2 is tilted back out of the maximum tilting position, to produce the same engagement ratios between the control chain 22 and toothed ring 31 on the upper mounting module 3.1 as on the lower mounting module 3.2.

When the casement 2 is pivoted back out of the tilting position, the control chain 22 moves upwards in FIG. 9 in the direction of the position II, the engagement between the chain and toothed ring taking place in the intermediate position of FIG. 9 and, as a result, the sector element 30 being pivoted upwards in the anticlockwise direction about the rotary pin 26, so that the pin 210 moves in the direction of the centre of the radial cam 320 while the plate 24 is held vertically by the support between the sector element 30 and chain 22 until the lower retaining pin 11′ of the frame comes to bear against the extension 35′ and the roller 25 engages in the horizontal guide 12, as FIG. 8 shows.

During the tilting movement of the casement 2, the retaining elements 33 on the lower mounting modules 3.2 and 3.4 are also no longer actively in engagement in the lower retaining pin 11′ of the frame 1. They are retained in the position of FIG. 7 by means of the link 37, which is supported on the pin 13 of the frame. The supporting of the casement 2 takes place solely via the rollers 25 in the horizontal guide 12 with guidance by the tilting modules 4.1 and 4.2. When the tilting movement of the casement 2 relative to the plate 24 about the shank of the roller 25 begins, the toothed ring 31 is released from the chain, so that the retaining element 33, in the position of FIGS. 7 and 9, no longer has any function on all four mounting modules 3.1 to 3.4.

The tilting movement of the casement 2 according to FIG. 1b is initiated by the two tilting lever modules 4.1 and 4.2 on both sides of the casement 2 (FIG. 2) while the control chain 22 is still in engagement with the toothed ring 31 on the mounting modules 3.1 to 3.4 in accordance with the position in FIGS. 6 and 8. The end of the control movement of the chain 22 into the position II according to FIG. 6 overlaps with the activation of the tilting lever modules 4.1 and 4.2, so that the control chain 22 is still in engagement with the toothed ring 31 of the mounting modules in accordance with FIGS. 6 and 8 while the engagement of the chain on the tilting lever module has already taken place, so that, when the chain is released from the toothed ring 31 when the tilting movement begins, the retaining and guiding function of the tilting lever modules 4.1 and 4.2 is already controlled by the chain 22 and a seamless transition of the sequence of movement from the mounting modules 3.1 to 3.4 to the tilting lever modules 4.1 and 4.2 takes place.

FIG. 10 shows, in a perspective illustration, a component of the tilting lever module which is attached to the casement 2 on both sides and is designed essentially in the form of a rectangular plate 41. A longitudinal groove in which the chain 22 is guided is referred to by 42. A toothed wheel 43 comes into engagement with the chain (not illustrated in FIG. 10), the said toothed wheel being fixedly connected to a smaller toothed wheel 44 which is arranged below it and is in engagement with a toothed strip 45, which is formed along one side of an elongate depression 46 along which the smaller toothed wheel 44 can be moved while the toothed wheel 43, which is situated above it and has a larger diameter, rests on the edges of this depression 46. The two toothed wheels 43 and 44 are connected fixedly to each other by a screw 47, the downwardly protruding shank of which is guided in a guide groove 48 which extends along the bottom of the depression 46. At the upper end 49 (in FIG. 10) of the depression 46 and of the guide groove 48, the latter is bent somewhat.

Eyelets 41′ for the fastening to the profile of the casement 2 are provided on the four corners of the plate 41. Furthermore, an upwardly protruding edge 41″ is formed around the larger toothed wheel 43 and extends at least as far as the upper side of the toothed wheel 43.

FIGS. 11 and 12 show that component of the tilting lever module which is reproduced in FIG. 10 on the casement 2 in a schematic illustration, it being possible for the casement 2 to be connected to the frame 1 via a tilting lever 40, as follows.

FIGS. 13a to 13e show part of the tilting lever module with an intercepting element 400 which is articulated at the end of the lever 40 which lies opposite the toothed wheels 43, 44. In FIG. 13, the frame 1 is indicated by chain-dotted lines and the casement is indicated by solid lines.

FIG. 14 shows a sectional view in the region of the articulation point between the lever 40 and intercepting element 400, which is connected to the lever 40 via an articulation pin 402, the articulation pin 402 protruding on both sides and engaging in a U-shaped groove 14 on the frame, which is indicated in FIG. 13. On the opposite side, the articulation pin 402 is of somewhat longer design and protrudes into a guide groove 29 on the casement 2, which groove is open counter to the guide groove 14 on the frame 1. In FIG. 13, the guide groove 14 is open on the frame 1 on the right side. In a corresponding manner, the guide groove 29, which is formed in the same manner, is open to the left on the casement 2, so that the articulation pin 402 can be released from the casement when it is fixed on the frame 1.

The intercepting element 400 has two grooves 401 and 401′ which extend on both sides of the sector-shaped intercepting element over a radius around the articulation pin 402 and end at a distance from the central line 403 of the intercepting element, on which a control extension 404 protrudes at the radially outer end and is in engagement with the chain 22 in the position 0 in FIG. 13a.

An intercepting pin 405 (FIG. 14) which comes into engagement with the intercepting element is fastened to the frame 1. At a distance parallel to the direction of movement of the chain 22, an intercepting element 406, which likewise comes into engagement with the intercepting element 400, is fastened to the casement 2.

In the closed position of the window according to FIG. 13a, the control chain 22 is in the position 0, in which the central line 403 of the intercepting element lies horizontally, as therefore does the control extension 404. In this case, the two intercepting pins 405 an 406 are situated in the open end region of the grooves 401 and 401′. The articulation pin 402 is situated in the guide 14 on the frame 1 and in the guide groove 29 (not illustrated in FIG. 13) on the casement 2. During the preliminary control movement of the chain 22 from the position 0 into the position I for tilting purposes, as FIG. 13b shows, the intercepting element 400 is pivoted in the clockwise direction about the articulation pin 402, on account of being in engagement with the chain, so that the lower intercepting pin 405 of the frame 1 bears against the inner end of the groove 401′ whereas the intercepting element 400 has been completely released from the upper intercepting pin 406 of the casement. In this preselection position for tilting purposes according to FIG. 13b, the tilting lever 40 is connected to the frame 1 by the fact that the support of the frame-side, lower intercepting pin 405 in the groove 401′ of the intercepting element means that the articulation pin 402 cannot be moved out of the guide-14 on the frame 1.

FIG. 13c shows the preselection position of the chain 22 from the position 0 into the position I′ for the pivoting of the casement, which will be explained in greater detail below. In this case, the opposed movement of the chain 22 pivots the intercepting element 400 in the anticlockwise direction, so that the upper, casement-side intercepting pin 406 comes to lie in the upper groove 401 of the intercepting element, as a result of which, during the pivoting movement (described below) of the casement 2 relative to the frame 1, the tilting lever 40 is retained in a manner bearing against the casement 2 by the fact that the articulation pin 402 is retained in the guide groove 29 on the casement 2 via the engagement of the intercepting element 400 with the casement-side intercepting pin 406 (corresponding to the retaining function in FIG. 13b in the guide groove 14 of the frame), so that, when the casement is pivoted, the articulation pin 402 is moved with the casement out of the guide groove 14 of the frame to the right in FIG. 13.

As can be seen from FIGS. 13b and 13c, during the preliminary control movement of the chain 22 from the position 0 into the position I or I′, the tilting lever 40 is already fixed to the frame 1 or secured to the casement 2, depending on whether a preselection has been made in the tilting direction or in the pivoting direction. After the preselection in the tilting direction, the casement 2 is lifted off to the right from the position in FIG. 13b, in which the case the articulation pin 402, which is fixed on the frame 1, results in a pivoting movement of the tilting lever 40 in the clockwise direction about this articulation pin (FIG. 11). That end 49 of the guide groove 48 which is bent in the component 41 of the tilting lever module lies on a radius around the articulation pin 402 in the position of FIG. 13b, so that the onset of the pivoting movement of the tilting lever 40 causes that end of the tilting lever which is provided with the toothed wheels 43, 44 to be moved out of the bent end 49, owing to the engagement of the smaller toothed wheel 44 with the toothed strip 45, and causes the toothed wheel 43 to come into engagement with the chain 22. This engagement already takes place during the lift-off movement of the casement 2 parallel to the frame 1 as the chain is moving from the position I into the position II, so that when the position of the casement is reached in which it is lifted off to the maximum, in FIG. 6, the tilting lever 40 is already able to execute the control and retaining function during the tilting movement by the chain 22, which moves from the position II into the position III, rotating the toothed wheel 43 in the clockwise direction in FIG. 11, as a result of which the tilting lever 40 in FIG. 11 is inevitably pivoted in the clockwise direction about the articulation pin 402 via the toothed wheel 44 which is in engagement with the toothed strip 45, and the casement is moved into the tilting position by the two tilting lever modules 4.1 and 4.2 while the upper mounting modules 3.1 and 3.3 are released from the frame 1 and the lower mounting modules 3.2 and 3.4 are supported on the frame via the rollers 25.

FIG. 11 shows the onset of the parallel lift-off movement of the casement 2 from the frame 1, in which the tilting lever 40 is pivoted in the clockwise direction about the articulation pin 402, which is fixed to the frame 1, with the result that the toothed wheel 43 comes into engagement with the control pins 23 of the chain 22.

FIG. 12 shows the tilting position of the tilting lever module, in which the shank of the connecting screw between the toothed wheels 43 and 44 bears against the lower end of the guide groove 48. FIG. 12 merely shows the lower mounting modules 3.2 in relation to the tilting lever module 4.1. The upper mounting module 3.1 lying in between is situated on the casement 2 in the position of FIG. 9.

FIG. 12 shows the casement 2 from the left side in FIG. 2 together with the lower mounting module 3.2 in the tilting lever module 4.1. Since the chain moves downwards during the control movement of the encircling chain 22 on this side of the casement, a control movement of the chain 22 upwards is produced on the opposite, right side of the casement. In order, despite this, to obtain the same control function of the tilting lever module 4.2 on the right side synchronously with the control function of the tilting lever module 4.1 on the left side, there is a linkage on the right tilting module 4.2 for reversing the movement between the toothed wheel 43, which is in engagement with the chain 22, and the smaller toothed wheel 44, which is in engagement with the toothed strip 45, and so, when the chain toothed wheel 43 rotates in the anticlockwise direction, the smaller toothed wheel 44 rotates in the clockwise direction and a synchronous tilting movement of the two tilting levers 40 is executed.

A linkage of this type between the two toothed wheels 43 and 44, which converts the rotational movement of the one toothed wheel into an opposite movement on the other toothed wheel, can be designed in various ways and is not illustrated specifically in the drawings.

When the casement 2 is moved back from the tilting position in FIG. 12 into the closed position, first of all the chain 22 is moved back from the position III into the position II (upwards in FIG. 12), as a result of which the toothed wheel 44 rolls upwards along the toothed strip 45 and the tilting lever 40 is thereby pivoted in the anticlockwise direction about the articulation pin 402 until the maximum parallel position in FIGS. 6 and 8 is reached, in which the chain 22 is already in engagement with the upper and lower mounting modules 3.1 and 3.2 on the toothed ring 31. In this case, the casement 2 is pivoted in the anticlockwise direction about the shank 27 of the roller 25 at all four-mounting modules and is aligned again with the plate 24.

Before a pivoting movement of the casement 2 according to FIG. 1c can be initiated, the casement has to be transferred into the closed position according to FIG. 4 by the chain 22 being moved back out of the position II into the position 0. By this means, the retaining element 33 is driven at the mounting modules 3.1 to 3.4 by the chain and is pivoted in the anticlockwise direction, thus carrying out the retrograde movement which is executed when the casement 2 is lifted off parallel from the frame 1.

During this closing movement from the position in FIG. 6 into the position according to FIG. 5, the supporting element 38 is lifted off upwards from the shank 27 via the link 37 on account of the pivoting movement of the retaining element 33, so that there is no longer any engagement between the shank 27 and supporting element 38, as FIG. 5 shows.

When the casement is pivoted back out of the tilting position in FIG. 12, during the control movement of the chain 22 from the position I into the position 0 the intercepting element 400 comes again into engagement with the chain 22, as a result-that, in the position 0, it takes up the initial position in FIG. 13a from which a preselection in the pivoting direction according to FIG. 13c can be undertaken.

Pivoting of the Casement

If the window is to be opened by pivoting from the closed position in FIG. 4, a preselection takes place by means of the control movement of the chain 22 from the position 0 in FIG. 4 upwards into a position I′, in which, according to FIG. 5, the lower retaining pin 11′ comes free from the recess 34′ or from the shoulder 36′ of the retaining element 33.

At the same time, the preliminary control movement of the chain at the two tilting lever modules 4.1 and 4.2 causes the tilting lever 40 to be fixed to the casement 2 (FIG. 13c), so that the articulation pin 402 can be moved out of the guide groove 14 of the frame 1 to the right in FIG. 13c. This takes place synchronously at both tilting lever modules 4.1 and 4.2.

Furthermore, the preliminary control movement of the chain 22 simultaneously activates the pivoting lever module 5, which is provided on the upper side of the casement 2 (FIG. 2), in such a manner that a pivoting lever 50 is fixed by one end to the frame 1 while its other end is articulated on the casement 2.

The pivoting lever module 5 can be designed in the same manner as the tilting lever module 4.1, the frame-side end of the pivoting lever 50 being fixed in a groove on the frame via an intercepting element by means of the preselection position of the chain 22 in the pivoting direction while the pivoting lever 50 is fixed to the casement 2 during the preliminary control movement of the chain in the tilting direction, as has been explained with reference to FIGS. 13 and 14.

After the described preselection position of the components has been executed by the preliminary control movement of the chain 22 at all four mounting modules 3.1 to 3.4, the two tilting lever modules 4.1 and 4.2 and at the pivoting lever module 5, in the next step the chain is moved on from the preselection position I′ in the direction of the position II′, so that the casement 2 is lifted off parallel from the frame. In this case, in order to reach the position in which the pivoting movement of the casement begins, the casement is not lifted off from the frame into the position in FIG. 6 in which it is lifted off to the maximum, but rather is lifted off only into a predetermined intermediate position, as will be explained below with reference to FIGS. 15 and 18.

FIG. 15 shows a view of the mounting module 3.4 from the right in FIG. 2, the frame 1 again being indicated by dashed lines.

In contrast to the mounting module 3.2 of FIGS. 4 to 7, the link 37 for the vertical displacement of the supporting element 38 is not articulated in the initial position on the retaining element 33 horizontally next to the rotary pin 26, but rather, in FIG. 15, is articulated on the left above the rotary pin 26 in such a manner that, in the initial position of the retaining element 33 according to FIG. 4, the upper articulation point 37′ lies in a line with the rotary pin 26, as FIG. 19 shows. FIG. 15 shows the preselection position I′ of the retaining element 33, in which the upper shoulder 36 of the retaining element has come free from the retaining pin 11 fastened to the frame 1. In other words, the position of the retaining element 33 in FIG. 15 corresponds to that in FIG. 5, but with a reversed preliminary control movement of the chain 22.

FIG. 16 shows a view of the mounting module from the left in FIG. 15. A bearing block 300 is attached to the plate 24 of the mounting module next to the retaining element 33, is arranged on an elongation of the plate 24, which extends to the left in FIG. 15, and extends with an elongated projection 300′ over the width of the plate 24. The bearing block 300 with the projection 300′ fits over a shoulder 305 on the frame 1 (FIG. 16), in which the horizontal guide 12 for the roller 25 is formed.

On the casement 2, as FIGS. 17 and 18 show, a bearing ball 302 is fastened via a projection 301 to the profile of the casement, in which the chain 22 is guided. In order to secure and fix the bearing ball 302 in the ball shell of the bearing block 300, a positioning screw 303, which has a bearing surface corresponding to the ball radius, is screwed into the said bearing block from above. FIG. 15 shows, at 304, a cutout on the bearing block 300, which permits a pivoting movement of the projection 301 of the casement relative to the bearing block. In the position of FIGS. 16 and 17, the casement is still in the bearing position on the frame 1. The control movement of the chain 22 in the direction II′ causes the retaining element 33 to be pushed away from the lower retaining pin 11′ of the frame 1 by the lower extension 35′, with the result that the roller 25 in FIG. 15 is displaced to the left in the horizontal guide 12 until the bearing block 300 protrudes with the pivoting joint out of the front plane of the frame 1, as FIG. 15 already shows irrespective of whether the retaining element 33 is only in the preselection position in FIG. 15. FIG. 18 shows the corresponding position of the bearing block 300 relative to the frame 1 while FIG. 17 reproduces the initial position from which the pivoting joint is displaced to the left in FIG. 17. FIGS. 17 and 18 show a view of the mounting module from below in FIG. 15.

In order to reach the initial position for the pivoting movement of the casement, the bearing block 300 is lifted off from the frame 1, from the position of FIG. 17 into that of FIG. 18, until the pivoting joint lies as close as possible to the frame and there is sufficient support via the rollers 25. In this case, additional support in the pivoting position according to FIG. 18 can be provided by the shoulder 305, which is reproduced in FIG. 16, via the horizontal guide 12.

The casement 2 with the mounting module 3.4, which is fitted thereto via the pivoting joint, is displaced to the left from the position of FIG. 17 into the position of FIG. 18, in which case the casement 2 is only lifted off from the frame 1 until the pivoting joint is exposed. During this lift-off movement, the pivoting lever module 5 is already in engagement with the chain 22, in which case the pivoting lever 50 is fastened to the frame 1, with the result that the further control movement of the chain 22 from the position II′ into the position III′ causes the casement 2 to be pivoted by the pivoting lever 50 into the pivoting position according to FIG. 18. In this case, the control pins 23 of the chain 22 are lifted off from the retaining element 33 transversely with respect to the plane of the toothed ring 31 on the said retaining element, as revealed in FIGS. 17 and 18, with the result that the chain 22 can be released from the toothed ring 31 from an engagement position, as reproduced in FIG. 15.

The control movement of the chain 22 from the preselection position I′ into the position II′ is configured to be shorter than the control movement from the position I into the position II when tilting. In a corresponding manner, the chain movement, which is required for pivoting the casement 2, from the position II′ into the position III′, in which the casement 2 is fully open, is designed to be longer so as to bring about the corresponding pivoting region at the pivoting lever 50. The pivoting lever 50, which is indicated schematically in FIG. 2, is expediently designed in the form of a multijointed pivoting lever 50, which is reproduced in FIG. 23 and in which the articulation points on the frame 1, on the one hand, and on the casement 2, on the other hand, lie opposite one another, as reproduced at 51 and 52 in FIG. 23. Other designs of the pivoting lever 50 may also be provided in order to permit a large pivoting region over at least 90° between the casement and frame. In the case of the pivoting lever 50 which is reproduced in FIG. 23, shorter links 503 and 504 are articulated in the central region on two links 501 and 502, which are connected in an articulated manner to each other, the said shorter links in turn being connected in an articulated manner to each other at the ends, so that a rhomboidal arrangement between these links is produced in the illustration of FIG. 23.

In order for the roller 25 to be fixed in the pivoting position according to FIG. 18 in the horizontal guide 12 and the mounting module to therefore be fixed relative to the frame 1, a further pin 15 (FIG. 15) is provided on the frame 1 above the horizontal guide 12 in the region of the two mounting modules 3.3 and 3.4, the said pin entering into engagement with the supporting element 38 while it fits over the shank 27 of the roller 25, with the result that the plate 24 is secured against tilting relative to the casement 2 in the pivoting position of the mounting module. In FIG. 15, the pin which is attached to the frame 1 and, in the position of the casement in which it is lifted off to the maximum according to FIG. 6, is used for holding the plate 24 relative to the casement 2 during the tilting movement, as has been explained with reference to FIGS. 6 and 7, is referred to at 13.

In FIGS. 19 and 20, only relative positions of the retaining element 33 of the mounting module 3.4 are reproduced, FIG. 19 reproducing the closing position corresponding to FIG. 4, in which the link 37 extends between the lifted-off position of the supporting element 38 over the rotary pin 26 to the upper articulation point 37′ on the sector element 30. The guide 28 on the plate 24 has an interruption 208, so that the guide 28, which is moved horizontally relative to the frame 1 by the plate 24, can be moved via the pin 15, which is used for fixing the pivoting position if the mounting module 3.4 has to be moved to the left in FIG. 19 into the tilting position in which an engagement with the pin 13 on the frame takes place in accordance with the illustration in FIGS. 6 and 7.

From the closed position of the casement in FIG. 19, a preliminary control movement of the chain 22 in the tilting direction into the position I is executed in the described manner, with the sector element 30 being pivoted in the clockwise direction in FIG. 19. In this case, during the lift-off movement of the casement from the frame from the position I into the position II (FIG. 20), the pin 15 on the frame 1 is first of all crossed by the guide 28 on the plate 24 with the supporting element 38 still raised, so that the engagement with the pin 13 during the further lowering movement of the supporting element 38 takes place in the position of the casement in which it is lifted off to the maximum.

If, in contrast, the preselection position of the chain 22 in the pivoting direction is executed from the position of FIG. 19, then the sector element 30 is pivoted out of the position of FIG. 19 in the anticlockwise direction, as a result of which, owing to the shorter distance which the link 37 covers, the supporting element 38 is lowered earlier than during the pivoting movement of the sector element 30 in the clockwise direction, and the oblique groove 39 on the supporting element 38 is already in engagement with the frame-side pin 15 when the pivoting position in FIG. 15 is reached.

The mounting module 3.3 (not illustrated) has, on the sector element 30, the radial cam 320, which is reproduced in FIGS. 8 and 9, for fixing the plate 24 in the tilting position and, at the same time, a link 37 which interacts with the frame-side pin 15 via the supporting element 38 in accordance with FIG. 15, so that the upper mounting module 3.3 is also fixed in the pivoting position on the frame 1. The frame-side pin 13 for the tilting position is not present in the region of the upper mounting module 3.3, and so the supporting element 38 cannot be fixed on the frame in the tilting position.

If the casement 2 is to be brought from the pivoting position in FIG. 18 into the closed position, the control chain 22 is moved back out of the position III′ (not reproduced in FIG. 15) into the position II′, thus enabling the pivoting lever 50 to be pivoted by the chain drive (corresponding to the drive of the tilting lever 40) and therefore enabling the casement 2 to be brought into the position parallel to the frame 1. In this position II′ of the chain, in which the casement 2 in FIG. 18 lies parallel to the horizontal guide 12 of the frame while the pivoting joint is still situated together with the bearing block 300 outside the plane of the frame 1, the control movement of the chain 22 from the position II′ into the position 0 causes the mounting module to be transferred from the position of the casement in which it is lifted off parallel into the closed position according to FIG. 17 and FIG. 19. This corresponds to the already described sequence of movement of the closing of the casement 2 from the lifted-off position in FIG. 6 into the position of FIG. 4.

A transfer from the pivoting position into a tilting position of the casement is again only possible if the casement 2 is transferred from the pivoting position into the closed position according to FIGS. 4 and 19 with the chain position 0, from which a preselection position in the tilting direction with the subsequent sequences of movement can be carried out. This operation of the window is therefore prevented since the starting point both for tilting and for pivoting has to be the position 0 of the chain, specifically in the opposite direction in each case from the position 0.

Motor Drive of the Chain

FIG. 21 shows, schematically, the driving module 6 (FIG. 2) which has an electric motor 60 and a worm 61 which is driven by the latter. The worm drives two spaced-apart worm wheels which are not reproduced in FIG. 21 and which drive the two toothed wheels 62 which are in engagement with the bearing pins 203 of the chain 22 in FIG. 21a. The worm wheels (not illustrated) are fixed on the two toothed wheels 62 and on a guide element 63 which extends parallel to the worm 61. This guide element 63 is supported on supporting elements 202 on the casement 2 via two spring plates 64 and 64′, a compression spring 66 being arranged between the two spring plates which are held on the shank of the guide element 63 via a spring ring or a transverse pin 65. As indicated by the double arrow in FIG. 21, the guide element 63 with the two toothed wheels 62 fixed on it can be moved both to the left and to the right counter 3.0 to the force of the spring 66.

This construction of motor 60, worm 61 and guide element 63 with toothed wheels 62 is guided on a component 67 of the casement 2 in guides 68 in such a manner that the entire driving unit can be lifted off from the position in FIG. 21a transversely with respect to the chain 22 into the position of FIG. 21b, in which the toothed wheels 62 are no longer in engagement with the control chain 22.

An end view of the construction is reproduced schematically on the left in FIG. 21a and FIG. 21b. The toothed wheels 62 are designed in this case in such a manner that they are in engagement with the bearing pins 203 which protrude laterally on the chain links and slide along a supporting surface 69 of the casement 2, so that the chain 22 is supported on an abutment when the two toothed wheels 62 are engaged.

The guide element 63 which is supported via the spring 66 has a dual function. When the toothed wheels 62 are brought from the disengaged position in FIG. 21b into engagement with the chain 22, an impact may arise during latching of the toothed wheels, in particular if the chain moves somewhat. This impact movement is intercepted by the spring 66 and by a corresponding deflecting movement of the guide element 63.

The second function of the guide element 63 which is supported by the spring 66 will be explained in greater detail in conjunction with the handle module 7 which is described below.

Manual Actuation of the Window

Instead of the chain 22 being driven by the motor 60, the chain may also be controlled manually by the handle module 7 which is reproduced in a schematic illustration in FIG. 22. A handle 70 is attached pivotably to the profile of the casement 2 and a release button 71 is attached to the handle, it being possible for the said button to be pressed by the fingers of the hand grasping the handle 70 in order to move, via a linkage of bars (not illustrated), the driving unit comprising the motor 60, worm 61 and guide element 63 with the toothed wheels 62 out of the engagement position in FIG. 21a into the position of FIG. 21b. The motor drive of the chain 22 is therefore disengaged by the release button 71 being pressed. A spring (not illustrated) is expediently provided between the component 67 and driving unit, the spring acting upon the driving unit in the engagement direction and having to be overcome by the release button 71 being pressed.

In the position in FIG. 22, the handle 70 is orientated downwards on the casement 2 corresponding to the customary closed position of a window. If the window is to be opened manually, the handle 70 is pivoted into the horizontal position in which the window is customarily opened by pivoting of the casement, or is pivoted upwards through 180° into the pivoting position, in which the window is customarily to be opened by tilting of the casement. During execution of these two pivoting movements at the handle 70, a connecting linkage (not illustrated) between the handle 70 and guide element 63 is used to adjust the latter in the one or other direction counter to the force of the spring 66, so that a preselection position for tilting or pivoting is implemented on the chain 22 via the toothed wheel 62, corresponding to the previously described positions I and I′.

The further control movement for opening the window in the tilting direction or pivoting direction can then be controlled via buttons 72, which are fixed on the handle module 7, by the fact that, for example, the OPEN button is pressed, causing the motor 60 to be activated via electric connecting lines in order to lift off the casement 2 from the frame 1 and to transfer it into the tilting or pivoting position in accordance with the position preselected by the handle 70. For this purpose, further buttons are provided on the handle module 7, as FIG. 24 also shows.

If, from the preselection position of the handle 70, the window is to be opened manually by the handle 70 being pulled, the release button 71 has to be pressed, so that the driving unit is disengaged from the chain 22, as FIG. 21b. The casement 2 is then lifted off parallel from the frame 1 by the handle 70 being pulled, in which case, owing to the engagement of the mounting modules 3.1 to 3.4 with the chain 22 because of the manually executed movement of the casement 2, the mounting modules are driven in such a manner that the retaining elements 33, which are released from the upper and lower retaining pins 11, 11′ by the preselection position of the handle 70, drive the chain 22, so that, in this case, the control movement of the chain is executed via the mounting elements. The sequence of movement of the mounting parts, on the one hand, and of the chain, on the other hand, is identical here with the previously described sequence of movement, in which the starting point has been that the chain 22 is moved into the one or other position by the motor 60. In comparison to the motor drive, the driving of the chain manually via the handle 70 with the button 71 pressed takes place via the mounting parts which are attached to the casement 2 and move the chain into the corresponding positions. In this case, the release button 71 can be let go, for example in a partially lifted-off position of the casement 2 parallel to the frame 1, so that, in an intermediate position of the chain, the casement is situated between the positions I and II in FIG. 6. During this latching movement of the driving unit on the chain 22 caused by the release button 71 being let go of, an impact may occur which is intercepted by the spring 66. Then, after the handle 70 is let go of, the window can be closed again or further opened by motor drive by the motor 60 being appropriately activated via the buttons 72 on the handle module 7 or by remote control (FIG. 24).

Owing to the permanent engagement of the encircling chain 22 with at least one of the mounting parts (for example, pivoting lever module 5) including the overlapping engagement with the tilting lever modules and the pivoting lever module, the position of the casement 2 relative to the frame 1 is defined at every instance by the position of the chain 22, irrespective of whether the chain 22 is driven and adjusted by the motor 60 or manually via the handle 70.

FIG. 22 shows five buttons 72 which can be used, by means of pressure on these buttons, to initiate the various functions or movements of the window casement. These buttons or sensor fields are connected via an electronic control system (not illustrated) to the driving motor 60, so that, by the particular buttons being pressed, the corresponding driving movement can be triggered at the motor 60. FIG. 24 shows, in the form of symbols, the various functions of the buttons, such as “parallel lifting off”, “tilting” and “pivoting” and also “window open” and “window shut”, on a remote control unit 100 (illustrated schematically).

The buttons provided on the handle module 7 may also be provided on another part of the casement, for example on the casement profile.

The preselection position of the handle 70 in the tilting or pivoting position has priority over an activation of the motor 60 in such a manner that, for example in a tilting position of the handle 70, activation of the motor 60 cannot lead directly to a transfer into a pivoting position. Depending on the preselection position of the handle 70, only a movement, corresponding to the preselection position, of the control chain 22 can be carried out by the motor 60 via the activation of the motor. There is a connection (not illustrated) for this via electric lines between the handle module 7 and driving module 6 so that, for example, a tilting position of the handle 70 blocks a drive of the motor 60 in the pivoting direction, which drive could be triggered from a remote control 100.

Modifications

Various modifications of the described construction are possible. Instead of a chain 22, a flexible strap may be provided on which corresponding control pins are fixed at least in some sections. Also, a toothed belt may be provided instead of a chain.

It is not necessary to form the chain with control pins 23 or a toothed belt continuously over the circumference of the casement/leaf 2. Control elements in the form of chain links or a section of a toothed belt may also be formed in some sections. Also, chain sections may be connected to one another via a spring element in order to compensate for an elongation of the control element due to the effect of temperature. A spring element of this type is configured in such a manner that it is not affected by, and does not bring about a change in length because of the forces of the adjusting movements by the motor drive and by the manual actuation, but only because of considerably higher forces, such as occur, for example, in temperature changes.

Instead of an individual driving module 6, a plurality of driving modules may also be provided on the circumference of a casement/leaf 2, in particular if it involves a relatively large door leaf. In the case of a relatively large door leaf, a plurality of the described mounting modules 3.1 to 3.4 may also be provided, for example three on each side of the leaf. The predetermined sequence of the individual chain positions from the position 0 in the one or other direction also makes it possible to use just a single driving module 6 or a single driving motor 60 to control all of the functions of the window.

The control of the casement 2 can be carried out by button control on the handle module 7, by remote control, for example by means of an infrared control device, or else by a central control system from which all of the windows of a building can be activated in this manner. Finally, it is also possible to actuate each individual window manually by a pivoting, pulling and pushing action on the handle 70, the motor drive in this case being uncoupled from the chain, so that the chain merely forms a coupling element for the mounting modules during the manually executed movements of the casement 2 relative to the frame 1.

If a remote control device 100 is to be used to activate a plurality of windows from a room, a laser pointer or the like is expediently provided on the remote control device and can be used to activate a corresponding sensor on the individual windows, with the result that by targeting the remote control device 100 at the relevant window which is to be opened, only this window responds and not the adjacent windows.

In a simplified embodiment of the described window or door construction, individual elements may also be omitted. It is therefore possible to omit the keyboard 72 on the handle module 7, which means that a window can only be actuated manually or by remote control. In the simplest embodiment, it is also possible to omit the driving module 6, so that the window can only be opened and closed manually, in which case, owing to the mounting modules which are permanently coupled together by the chain, the casement 2 can be stopped in any desired position, for example in a position in which it is lifted off only approximately parallel, for ventilation purposes or the like. In this case, instead of the driving module 6, a separate catch is provided on the chain 22 and fixes the chain in a certain position if it is not released by the button 71 on the handle 70. If a driving module 6 is fitted subsequently, a catch of this type for the chain 22 is replaced by the driving module.

In FIG. 2, only cutouts on the frame 1 and on the profile of the casement 2 are indicated for the supply module 8. The supply module is expediently arranged at a location on the circumference of the casement at which as few movements relative to the frame 1 as possible take place. The supply module is therefore positioned, for example, above the right, lower corner. The supply module (not illustrated) comprises supply cables and connecting plugs which are inserted into the profile of the casement, the cables being connected to the motor 60 of the driving module 6. The electronic control unit can be formed on the supply module or else on the driving module. The connection of the supply module on the casement to the module on the frame 1 takes place via connecting cables having plugs at the ends.

The shank 27 on the mounting modules 3.1 to 3.4 can also be fixed by a spring-loaded catch in the position of FIG. 6, in which the casement takes up the position in which it is lifted off to the maximum parallel to the frame 1.

The sensor module 9 is preferably provided on a corner of the window construction at which the fewest adjusting movements of the casement occur. The sensor module is therefore fixed, for example, to the right, lower corner.

In the exemplary embodiment described, the control element in the form of the chain 22 with the various mounting modules is attached to the casement 2. It is also possible to attach the encircling control element with the mounting modules controlled by it to the frame 1; however the attachment to the casement 2 is advantageous in terms of installation and repair work and the replacement of individual components.

In particular, the engagement element on the individual mounting modules may also be designed in a different manner than illustrated. Thus, instead of a toothed ring which enters into engagement with the control pins of the chain, a worm spindle or the like can be provided for displacing a mounting part.

Instead of the roller 25, which supports the load of the casement on the frame, a lever construction may also be provided in order to support the casement on the frame.

Instead of the supply module which is indicated in FIG. 2 with current being fed via electric lines, the feeding of power to the driving unit, which is accommodated in the casement profile, may also take place without lines, for example inductively. Similarly, control signals may be transmitted to the electronic control unit or the driving unit via radio, so that the control element executes the corresponding control movements, with the result that a supply module having electric lines between the casement and frame is not required.

In order to sense the positions of the casement relative to the frame, a plurality of sensors may be provided on the circumference of the casement in order to directly sense the position of the casement. By virtue of the fact that all of the sequences of movement of the casement relative to the frame are clearly defined by the sequential succession of control movements of the chain 22 from the initial position 0 in the one or other circumferential direction, it is also possible for just an individual sensor to be provided, for example the sensor indicated in FIGS. 2 to 9, which is in engagement with the chain 22 and indirectly determines the position of the casement by means of the sensed position of the chain 22 relative to the initial position 0 and relative to the casement. This clear definition of the chain movement also prevents misoperation of the casement.

The preliminary control movement of the chain 22 by the handle 70 can also be executed in such a manner that, when the handle 70 is pivoted from the closed position into the tilting or pivoting position, the release button 71 is pressed and, via a coupling element between the handle 70 and chain 22, the latter is moved by the pivoting movement of the handle into the preliminary control position I or I′ while the driving unit is disengaged from the chain by the release button 71. If the window is to be subsequently opened by means of the handle, this coupling device is likewise released from the chain 22, so that the latter can move freely over the mounting elements because of the manual movement on the casement. An additional actuating device may be provided for this coupling between the handle 70 and chain 22 for the purpose of executing the preliminary control movement when the driving unit is disengaged.

FIGS. 25 to 35 show a preferred embodiment of mounting modules on a window construction, the same reference numbers as in the preceding figures are used for the same components. In this embodiment too, the casement 2 of the window executes the movements, which are reproduced in FIGS. 1a-1c, relative to the frame 1.

FIG. 25 shows, schematically, corresponding to FIG. 2, the arrangement of the various mounting modules on the circumference of the window construction, in which, in comparison to the embodiment according to FIG. 2, the tilting lever modules 4.1 and 4.2 are dispensed with and the driving module 6 is arranged on the pivoting lever module 5, which at the same time carries out the tilting lever function. On the sides of the frame 1, in the region of the mounting modules 3.1, 3.2, 3.3 and 3.4, individual retaining pins 101 are fastened to the frame 1 and enter into engagement with these mounting modules.

FIG. 26 shows, in a perspective illustration and schematically, the construction of a mounting module 3.1 on the casement 2 in conjunction with the retaining pin 101 on the frame 1. The mounting module 3.1 comprises a control slide 102 which is connected to the control element 22 and from which protrude, in the exemplary embodiment illustrated, four guide pins 103 which engage in slots 104 in a plate-like mounting part 105 which is attached fixedly to the casement 2 of the window, as FIG. 31 shows. The control slide 102 has a control groove 106 which is reproduced in detail in FIG. 27 and, in this exemplary embodiment, is of approximately V-shaped design and in which the retaining pin 101 of the frame 1 engages. This retaining pin 101 engages at the same time in a horizontal groove 107 on the mounting part 105, on which the control slide 102 is guided in a manner such that it can be displaced in the direction of movement of the control element 22. The control element 22 which is guided in a circumferential groove of the casement 2 can be designed as a strap, chain or cable.

FIG. 27a shows, schematically, a side view of the mounting module 3.1 in the locking position, in which the retaining pin 101 of the frame 1 is situated at the inner end of the horizontal groove 107 of the mounting part 105, which is fixed on the casement, and at the same time is situated at the vertex 106.1 of the radial cam 106 of the control slide 102. At the vertex 106.1, the control groove 106 is slightly flattened transversely with respect to the horizontal groove 107, so that the retaining pin 101 can take up a stable position in the locking position of the window.

FIG. 27b shows a position of the mounting module 3.1 during pivoting of the casement 2 relative to the frame 1, the retaining pin 101 of the frame being situated in a horizontal section 106.3 of the radial cam 106 that is connected to the apex 106.1 via an oblique section 106.2. This relative position in FIG. 27b corresponds to the position in which the casement 2 is released from the frame 1, and it is brought about by a displacement of the control slide 102 upwards from the position in FIG. 27a, the control slide 102 having been moved upwards in the pivoting direction of the casement by means of the control element 22 by the driving motor or manually via the handle module 7. On further movement of the casement, the retaining pin 101 of the frame 1 slides out of the horizontal groove 107 and at the same time out of the horizontal section 106.3 of the control groove, so that the mounting module 3.1 can be released from the frame 1, as FIG. 27d shows in conjunction with a tilting position.

FIG. 27c shows a tilting position of the mounting module 3.1 after the control slide 102 has been moved downwards out of the locking position in FIG. 27a by the driving module 6 or the handle module 7. This causes the retaining pin 101 to move along an oblique section 106.4 of the radial cam on the control slide 102 while the retaining pin 101 moves at the same time in the horizontal direction along the horizontal groove 107 of the mounting part 105. As FIGS. 27a and 27b show, the longer section 106.4 of the control groove is open over a short section 106.5 on the left side, with the result that, if the tilting movement of the casement continues, the retaining pin 101 can be released from the horizontal groove 107 and the control groove 106, as FIG. 27d shows.

The two obliquely extending sections 106.2 and 106.4 have essentially the same inclination relative to the horizontal and are also identical in length. However, they may also differ in design.

That section 106.4 of the radial cam which corresponds to the lower section 106.2 is used for the release of the casement from the frame 1, in accordance with FIG. 27b (position 1 in FIG. 34a). The extending oblique section 106.4 is used for guiding the retaining pin 101 on the casement 2 during the parallel lifting-off and during the tilting movement while the retaining pin 101 in the horizontal groove 107 still bears the load of the casement 2, and then, towards the end of the movement, the retaining pin 101 passes to the left end of the horizontal groove 107 and into the short horizontal section 106.5 of the radial cam, from which the retaining pin 101 can be released from the mounting module 3.1, as FIGS. 27c and d show.

The construction which is described for the mounting module 3.1 is also provided in basic principle for the mounting modules 3.2 to 3.4 where the control groove 106 on the control slide 102 is of different design because of the different functions of these further mounting modules. FIG. 28 shows the different designs schematically, all of the positions reproducing the locking position from which the retaining pin 101 is moved into the upper or lower section of the control groove 106 while it is moved at the same time in the horizontal direction in the control groove 107.

FIG. 28a corresponds to the design of the mounting module 3.1, in which the two legs of the approximately V-shaped control groove 106 are open at the outer end as is the horizontal groove 107 on the mounting part 105, so that the retaining pin 101 can be released from the frame 1 both in the pivoting position of the casement and also in the tilting position of the casement. The horizontal double arrow indicates the movement of the retaining pin 101 in the horizontal groove 107, and the vertical double arrow indicates the movement of the retaining pin 101 in the two limbs of the control groove 106. The position in FIG. 28a corresponds to the locking position in FIG. 27a.

FIG. 28b shows the shape of the control groove 106 on the mounting module 3.2, at which the casement 2 has to be held on the frame 1 in the tilting position while, in the pivoting position of the casement, the mounting module 3.2 has to be released from the frame 1. Therefore, on the mounting module 3.2, the upper end 106.6 of the obliquely extending section 106.4 of the control groove is closed, so that, in the tilting position of the casement, the retaining pin 101 of the frame is held in the mounting module 3.2 by the retaining pin 101 bearing against the closed end 106.6 of the control groove while, in the pivoting position, the retaining pin 101 can be released from the mounting module 3.2 by the lower, open section 106.3 of the control groove.

At the closed end 106.6 of the upper oblique section 106.4 of the control groove, FIG. 27c shows the tilting position of the casement 2 relative to the frame 1 on the mounting module 3.2, the retaining pin 101 being held in the mounting module by the closed end 106.6 of the control groove while at the same time the load of the casement 2 is supported on the retaining pin 101 via the horizontal groove 107.

FIG. 28c shows the shape of the control groove 106 on the mounting module 3.3, at which the retaining pin 101 has to be released from the mounting module in the tilting position of the casement 2 while, in the pivoting position of the casement, the retaining pin 101 has to be held tightly against the mounting module. It should be taken into account here that on the two mounting modules 3.3 and 3.4 on the right side of the window construction, the lower sections of the radial cam 106 in FIGS. 28c and d correspond to the upper sections of the radial cam on the mounting modules 3.1 and 3.2 according to FIGS. 28a and b because the control slide 102 on the right side of the casement is moved upwards when the control slide 102 on the left side of the casement is displaced downwards, and vice versa. Therefore, in FIG. 28c, the lower limb 106.4 and 106.5 of the control groove corresponds to the upper limb in FIG. 28a because the mounting module 3.3 has to be released from the frame 1 during tilting of the casement. In contrast, the upper limb 106.2 in FIG. 28c, which corresponds to the lower section 106.2 on the two left mounting modules 3.1 and 3.2, is provided with a closed end 106.7, so that, in the pivoting position of the casement, the connection between the casement and frame is maintained by the retaining pin 101 bearing, after being released, against the end 106.7 of the control groove while it is held at the same time in the horizontal groove 107. The length of the upper section 106.2 in FIG. 28c corresponds to the length of the lower section 106.2 in FIG. 28a or to the distance necessary for releasing the casement from the frame. After the casement has been released, the retaining pin 101 comes to bear against the closed end 106.7 of the control groove, so that it is held on the mounting module 3.1, with the result that then a pivoting movement of the casement 2 relative to the frame 1 can be initiated.

FIG. 28 shows, by means of the arrows “tilting” and “pivoting” on the mounting modules 3.1 and 3.2, and in the opposed direction on the mounting modules 3.3 and 3.4, the opposed design of the radial cam 106 which arises on account of the opposed movement of the control element 22.

FIG. 28d shows the shape of the control groove 106 on the mounting module 3.4, at which the casement 2 is not released from the frame 1 in any position. The horizontal groove 107 at the left end is therefore also closed so that the retaining pin 101 cannot be released from the mounting module 3.4 and the weight of the casement 2 is supported in every position on the retaining pin 101 of the frame. Furthermore, the two sections 106.2 and 106.4 of the control groove 106 are of closed design at the ends. The section 106.4 corresponds to the upper section 106.4 in FIG. 27b, the closed end 106.6 holding the retaining pin 101 in the released position in the mounting module 3.4 (in accordance with the illustration in FIG. 27c). The upper, shortened limb 106.2 of the control groove in FIG. 28d corresponds to the design in FIG. 28c.

FIG. 29 shows a sectional view through the construction of the mounting modules, in which two roller bearings 101.1 and 101.2 of different diameter are fixed on the retaining pin 101 of the frame 1. The roller bearing 101.1 of larger diameter is situated in the horizontal groove 107 of the mounting part 105 while the roller bearing 101.2 of smaller diameter engages in the control groove 106 of the control slide 102. By means of this design, firstly, erroneous positioning during installation is prevented and, secondly, the control movement is helped to run smoothly.

FIG. 30 shows, schematically, a sectional view corresponding to FIG. 29, in which the fastening is of the plate-like mounting part 105 on the casement 2 is indicated. The control slide 102 is guided by the pins 103 in the vertical guide slots 104 (FIG. 27) of the mounting part 105, an engagement element 108 being attached to the control slide 102 and being in engagement with the control element 22 (reproduced schematically by a double arrow) which is guided displaceably in a groove on the circumference of the casement 2. As FIG. 30 shows, one mounting module combines a total of three guides, a vertical guide for the control slide 102, a horizontal guide for the retaining pin 101 in the mounting part 105 and the guide for the retaining pin 101 in the control groove 106. The mounting part 105 can be designed overall as a flat housing in which the control slide 102 is guided.

FIGS. 31 and 32 show, schematically, a view from above of one of the mounting modules 3.3 and 3.4 on the right side of the casement where a hinge has to be provided between the frame 1 and casement 2 in order to permit a pivoting movement of the casement. In the embodiment according to FIG. 31, one part of a hinge 109 is fastened in each case to the mounting module 3.3 and 3.4 and to the mounting part 105 thereof and its other part is connected to the casement 2. FIG. 31a and FIG. 32a show the mounting module in the locking position, in which the casement 2 bears against the frame 1 or lies in the frame. FIG. 31b and FIG. 32c show a pivoting position of the casement 2 of approximately 45°. A curved strap 110 which is curved concentrically about the hinge axis, is fastened in each case to the control slide 102 of the mounting module 3.3 and 3.4 and engages in a recess of the strap-like control element 22. This curved strap 101 corresponds to the engagement element 108 (which is reproduced in FIG. 30) between the control slide 102 and control element 22. By means of this curved strap 110, a connection between the control element 22 and control slide 102 is maintained in every pivoting position of the casement 2, with the result that, in every position of the casement 2, the relative position between the control slide 102 and control element 22 is defined.

FIG. 32b shows the casement 2 in the position in which it is lifted off parallel from the frame 1 and in which the hinge 109, which is fixed on the outside of the mounting module, is lifted off from the frame 1, in which case the pivoting movement is then initiated, as FIG. 32c shows. In FIG. 31, a plate of the hinge 109 that is fastened to the casement 2 is referred to by 2.1 while the mounting module 3.3 or 3.4 forms the other plate of the hinge 109 that is held on the frame in the parallel lifted-off position of the casement, with the result that the weight of the casement is supported on the frame via the retaining pin 101.

FIG. 33 shows, schematically, a combined pivoting and tilting lever module 5, in a pivoting position of the casement 2 in FIG. 33b, and in a tilting position in FIG. 33a, the mounting part 105 with the horizontal groove 107 being indicated schematically on the upper mounting modules 3.1 and 3.3. The pivoting and tilting lever module 5 has a pivoting lever 111 and a tilting lever 112 which are both articulated on a slide 113 (FIG. 34). Intercepting elements 114 and 115 (indicated schematically in FIG. 33) are formed on the frame 1, the tilting lever 112 entering into engagement with the intercepting element 114 before the tilting movement is initiated and the pivoting lever 111 entering into engagement with the intercepting element 115 before the pivoting movement is initiated.

FIG. 34 shows, schematically, the construction of this pivoting and tilting lever module 5, FIG. 34a reproducing a plan view from above of a position of the mounting module in which a tilting movement of the casement 2 relative to the frame 1 is executed. FIG. 34b shows a side view in the position of the mounting module of FIG. 34a, while FIG. 34c reproduces a view from the right in FIG. 34a.

As FIGS. 34a and b show, the axes of articulation 111.1 and 112.1 (FIG. 35b) of the pivoting lever 111 and tilting lever 112 can be displaced on the slide in the circumferential direction of the casement 2 in a slot 117 (FIG. 34a). The spindle 116, which is mounted rotatably in the bearing points 118 on the profile of the casement 2, is designed without self-locking and is set into rotation by an electric driving motor 60 of the driving module 6, which is likewise arranged in the profile of the casement 2.

In the locking position of the casement 2 on the frame 1, the casement 2 is situated essentially within the frame 1, in which case the slide 113 is situated in the position 0 and the two levers 111 and 112 are aligned in the circumferential direction on the casement 2 and are not in engagement with the intercepting elements 114 and 115, which are positioned on the frame in an extension of the two levers 111 and 112. As a result of the fact that the two intercepting elements 114 and 115 lie in a line with the two levers 111 and 112 in the initial and locking positions, during a displacement of the slide 113 in the one or other direction from the position 0, the particular lever 111 or 112 can be introduced into the associated intercepting element, whereupon further displacement of the slide 113 initiates the tilting or pivoting movement of the casement.

If, in the locking position, for example “tilting” of the casement 2 is selected by remote control via the control device 100 (FIG. 24), the slide 113 is displaced by the motor 60 from the position 0 into the position 1, which is on the left in FIG. 34a and in which the casement is released from the frame, in which case a ball 120, which is fixed on the free end of the tilting lever 112, is introduced during the release process into a guide channel 119 of the intercepting element 114. The balls 120 at the free ends of the levers 111 and 112 are of flattened design, so that they can be introduced into the guide channel 119 of the intercepting elements 114 and 115, whereupon, after a pivoting movement of the relevant lever 111 or 112 relative to the connecting line of the intercepting elements 114, 115, the flattened ball is reliably held in the ball socket 121 by twisting.

In the position 0, the slide 113 is connected to the control element 22, so that during the displacement movement of the slide 113 from the position 0 into the position 1, the control slides 102, which are connected to the control element 22, on the mounting modules are also displaced, as a result of which the casement 2 is released from the frame 1.

When the slide 113 has reached the left position 1, the casement 2 is released via the corresponding displacement of the control slides 102 on the mounting modules 3.1 to 3.4, in which case the ball 120 at the free end of the tilting lever 112 is already situated in the ball socket 121 of the intercepting element 114, so that, on further displacement of the slide 113 in the direction of position 2, the tilting lever 112 is guided in an articulated manner in the intercepting element 114. FIG. 34a shows an intermediate position of the tilting movement, the slide 113 being situated between the positions 1 and 2. The position 2 corresponds to the position of the casement in which it is lifted off parallel.

The slide 113 is guided on the profile of the casement 2 by a longitudinal guide 122 (indicated schematically in FIG. 34c) while the spindle 116 rotates in the one or the other direction, as indicated by the double arrow in FIG. 34c. At the same time, the slot 117 forms a longitudinal guide for the axis of articulation of the levers 111 and 112.

In the case of the exemplary embodiment which is reproduced in FIG. 34a, the distance over which the slide 113 is moved from the locking position 0 into the released position 1 in the “tilting” direction is configured to be greater than in the “pivoting” direction, so that the hinge 109 (FIG. 31) arranged between the casement 2 and frame 1 clearly comes free from the frame during tilting of the casement.

In contrast, the distance over which the slide 113 is displaced into the released position in the pivoting direction can be kept short because the hinge 109 remains in the corner between the casement 2 and frame 1 during pivoting of the casement.

In the case of the exemplary embodiment illustrated in FIG. 34, the slide 113 is connected to the control element 22 only in the locking position 0 and during the displacement into the position 2 for parallel lifting-off of the casement while, during the further adjusting movement of the slide 113 in the “tilting” or “pivoting” direction from the position 2, the slide 113 is decoupled from the control element 22 and the pivoting or tilting movement of the casement is controlled just via the levers 111 and 112, respectively, while the control element 22 is latched in its position on the casement 2.

FIG. 35 shows, schematically, the coupling mechanism between the slide 113 and the strap-like control element 22, in which FIG. 35a reproduces the coupling position between the slide 113 and control element 22 and FIG. 35b reproduces the decoupled position, in which the strap-like control element 22 is secured in its position by a catch 128, which is supported on the casement 2 by a spring 127, while the side can continue to move without the position of the control element 22 being affected as a result.

The slide 113 is guided via a guide pin 123, which is preferably provided with a roller bearing, in a radial cam 124 which is formed on the casement 2 or on the circumferential profile thereof. In the locking position and during the adjusting movement for parallel lifting-off, the control pin 123 is situated in the offset section 124.1 of the radial cam, the slide 113 engaging via an engagement element 125 in a recess 126 of the control element 22, so that the control element 22 moves synchronously with the slide 113. In the position 2 in FIG. 34a, i.e. at the end of the parallel lifting-off of the casement, the radial cam 124 is provided with an oblique section 124.2, the angle of inclination of which corresponds to the angle of inclination of the flank of the engagement element 125 into the recess 126, which is provided with oblique flanks, on the control element 22, so that, on further displacement of the control element 22 in the “tilting” or “pivoting” direction, the engagement element 125 slides out of engagement with the control element 22 while the engagement pin 123 is displaced into an outer section 124.3. When the control pin 123 is situated in the section 124.3 of the radial cam 124, this corresponds to a position of the slide 113 on that side of the position 2 in FIG. 34a in which the slide 113 is decoupled from the strap-like control element 122, as FIG. 35b shows.

In the exemplary embodiment according to FIG. 35, the coupling mechanism between the slide 113 and strap-like control element 22, on the one hand, and between the control element 22 and casement 2, on the other hand, has a ram 129 which engages by means of a V-section in the V-shaped recess 126 of the control element 22 and lies with the opposite, widened end in a correspondingly widened recess 130 of the control element 22. As FIG. 35a shows, the ram 129 is held in a manner bearing against a fixed part of the casement 2 by the engagement element 125 while the engagement element 125 engages in the recess 126 for connection between the control element 22 and slide 113. In this position in FIG. 35a, the catches 128, which are loaded by the springs 127, bear against the strap-shaped control element 22 while the latter is being displaced relative to the casement 2.

As soon as the slide 113 has reached the end position 2 (FIG. 34a) during the parallel lifting-off of the casement and the control pin 123 is situated in the lower section 124.3 of the radial cam 124 (FIG. 35b), the control element 22 is also situated in a position in which the widened recess 130 lies opposite a catch 128, thus enabling the spring-loaded catch 128 to push the tappet 129 back into the position reproduced in FIG. 35b and the catch 128 to engage in the recess 130 of the control element 22, so that the latter is fixed in this position.

When the slide 113 is moved back again from the position in FIG. 35b into the locking position 0 (FIG. 34a), then the engagement element 125, which is pushed upwards in FIG. 35b by the control pin 123 in the control groove 124, likewise pushes the ram 129 upwards, so that the catch 128 is pushed out of engagement with the recess 130 of the control element 22 and the control element 22 can be displaced to the right in FIG. 35b synchronously with the slide 113 on account of the engagement with the engagement element 125. The catch 128 which is on the right in FIG. 35b corresponds to the position 2 which is on the right in FIG. 34a (end position during parallel lifting-off of the casement), in which case the same latching operation takes place as illustrated in FIG. 35b at the left catch 128.

The engagement element 125 is guided between two guides 131 transversely with respect to the movement of the slide. Guide pins on the casement 2 for the levers 111 and 112 are referred to by 113.1, and, in the position in FIG. 34a, the lever 111 which is not active is situated between the spaced-apart guide pins 113.1. During the displacement movement of the slide 113 in the pivoting direction, the lever 112 comes to lie between these guide pins while the lever 111 is moved out of the guide, so that, after engagement with the intercepting element 115., it can control the pivoting movement of the casement.

The decoupling of the slide 113 from the control element 22 during the tilting and pivoting movements of the casement 2 has the effect that the tilting and pivoting movements are controlled solely by the levers 111 and 112 while the control slides 102 on the individual mounting modules remain in their position during the tilting and pivoting movements because of the control element 22, which is latched to the casement 2.

The mountings 3.1 to 3.4 in the embodiment according to FIGS. 25 to 35 have essentially the same construction, unlike in the embodiment according to FIGS. 2 to 21. Furthermore, a substantial simplification is produced by the fact that the driving module 6 is combined with the tilting and pivoting lever module 5 and the tilting and pivoting levers 111 and 112 are alternatively connected to the frame by articulation in the intercepting elements 114, 115 on the frame 1.

In the embodiment according to FIGS. 25 to 35, the handle 70 or the handle module 7 can have the same design as in FIG. 22 with the keyboard 72 and button 71. In order for it to be possible for the window construction to be actuated independently of the driving motor 60 via the handle module 7, the handle 70 is connected via a control cable (not illustrated) to a coupling 137 (FIG. 34b) which, by actuation of the button 71, interrupts the connection between the motor 60 and spindle 116, whereupon the pivoting movement of the handle 70 causes a control pin on the shank of the handle 70 to engage in a slotted guide with control grooves which is fixed on the strap-like control element 22, so that the movement of the handle causes the control element 22 to be displaced on the circumference of the casement 2 in such a manner that the casement can be lifted off parallel in order to initiate the desired tilting or pivoting movement, the control element 22 in this case driving the slide 113 from the position 0 into the positions 1 and 2 (FIG. 34a) while the tilting or pivoting movement is controlled exclusively via the tilting and pivoting levers 111, 112, by appropriate pulling on the handle 70, since, even when the window construction is actuated manually, the slide 113 is decoupled from the control element 22 in the position 2.

As soon as the casement 2, by means of pressure on the handle 70, is moved again from the pivoting or tilting position into the position 2 in which it is lifted off parallel, the slide 113 is coupled to the control element 22 (FIG. 35). By further pressure on the handle 70, the casement is moved parallel to the frame from the position 2 into the position 1. The coupled control element 22 ensures that the sequence of movements is synchronous. Rotation of the handle 70 into the closed position causes the control element 22, and with the latter the control slide 102 on the mounting modules, to be displaced in such a manner that the casement 2 is moved into the locking position 0 on the frame 1.

In the embodiment according to FIGS. 25 to 35, the control element 22 may also be designed as a strap section which does not extend over the entire circumference of the casement 2, but rather extends only from the mounting module 3.2 over the mounting module 3.1 to the mounting module 3.4. In this case, the control element 22 has to be of correspondingly rigid design. The control element 22 is preferably designed as a closed-control cable which extends over the entire circumference of the casement 2. In this case, deflection rollers are preferably arranged at the corners of the casement in order to enable the adjusting movement of the cable on the circumference of the casement to run smoothly.

Also in the embodiment according to FIGS. 25 to 35, the casement 2 can be moved from any desired position into the closed position if, for example, a rain sensor indicates rain and causes a corresponding electronic control unit to activate the motor 60 for the purpose of closing the window. Owing to the fact that in the positions 0 to 2 the casement 2 is connected via the control slide 102 to the retaining pin 101 of the frame, the window can be moved from the position in which it is lifted off parallel into the closed position by the driving motor 60 which drives the slide 113. If the casement 2 is in a tilting or pivoting position, then the motor drive of the slide 113 first of all moves the casement 2 into the position 2 in which it is lifted off parallel and from which the closing operation then takes place.

The closed position of the casement 2 is already achieved in position 1 shortly before the retaining pins 101 pass into the apex 106.7 (FIG. 27) of the control groove 106. The rest of the movement of the retaining pins 101 as far as the end position of the apex of the radial cam corresponds to the compression of the window seal.

FIG. 36 shows a modified embodiment of the tilting and pivoting lever module 5, in which, in contrast to the embodiment according to FIG. 33, there is only one lever 140 between the frame 1 and casement 2 both for the tilting movement and for the pivoting movement. In this design, a parallel lifting-off of the casement 2 before the pivoting movement is initiated, i.e. the displacement between the position 0 and the right position 1 in FIG. 34a, can be dispensed with when the slide 113 is displaced from the locking position 0 in the pivoting direction of the casement. In this case, the hinge 109 between the mounting modules 3.3 and 3.4 and casement 2 (FIG. 31) remains in the same position as in the locking position, with the result that a pivoting movement of the casement 2 is initiated directly from the locking position. The control element 22 is coupled to the mounting modules 3.3 and 3.4 via the hinge pin of the hinge 109. The control slide of the mounting modules 3.3 and 3.4 is always mechanically in engagement with the control element 22.

FIG. 36a shows, schematically, the lever position during tilting of the casement 2. The lever 140 is articulated fixedly on the upper side of the frame 1 in the vicinity of the right corner at 141 while its opposite end 142 is guided in an articulated manner in a slot 143 of the casement 2. A further lever 144 is articulated approximately in the central region of the lever 140 at 145 and its opposite end 146 is articulated on the slide 113, which, as indicated by a double arrow, can be displaced along the upper side of the casement 2 by the driving module 6 in accordance with the embodiment according to FIG. 34.

In the closed position of the window, the longer lever 140 lies in a line with the shorter lever 144 between the articulation points 142 and 146. From this locking position 0, a slide movement 113 in the tilting direction causes the casement 2 to be lifted off parallel from the frame 1, as is also the case in the previously described embodiment. After the position 2 is reached, the slide 113 is decoupled from the control element 22, so that the further tilting movement in FIG. 34a is executed just by the lever 140 with control by the shorter lever 144. In order to close the window from the tilting position, the point of articulation 146 of the control lever 144 is displaced to the right in FIG. 36a by the slide 113, as a result of which the point of articulation 142 in the slot 143 is shifted to the left in FIG. 36a until the casement 2 reaches the position 2 in which it is lifted off parallel and from which the mounting modules 3.1 to 3.4 execute the closing movement of the casement 2 in parallel in conjunction with the movement of the control element 22 that is guided by the slide 113.

FIG. 36b shows a pivoting position of the casement 2 by means of the tilting and pivoting lever module 5, in which the pivoting movement does not take place from the position of the casement in which it is lifted off parallel, but rather directly from the release position 1. In this case, the control element 22 is first of all moved by the slide 113 somewhat in the pivoting direction, so that the retaining pin 101 is moved out of the locking position 0 at the apex 106.1 of the radial cam 106 of the mounting modules 3.1 to 3.4 into position 1. However, a further control movement of the control element 22 is no longer required, with the result that, right after this short adjusting movement of the slide 113, the latter can be decoupled from the control element 22, so that the further pivoting movement is executed solely by the levers 140, 144. Since, during the pivoting, the mounting modules 3.3 and 3.4 on the right side of the casement 2 are not released from the frame 1, during the further displacement of the slide 113 to the right on the casement 2, the lever 140 is pivoted about the point of articulation 141 on the frame 1 by means of the control lever 144, as FIG. 36b shows. By virtue of the fact that the point of articulation 142 of the lever 140 is guided in a slot 143 on the casement 2, the pivoting movement of the casement about the axis of the hinge 109 can be executed.

FIG. 37 shows the arrangement of the hinge 109 on the mounting modules 3.3 and 3.4 on the outer edge of the casement 2. This arrangement of the hinges 109 on the outer edge of the casement permits the casement to be pivoted directly from the closed position which is reproduced in FIG. 37.

In order to close the window from the pivoting position in FIG. 36b, the slide 113 is displaced again in the direction of the centre of the casement, so that the lever 140 is pivoted in the clockwise direction about the point of articulation 141 until it reaches the position 1. From position 1, the slide 113 is coupled again to the control element 22, thus permitting the control element to be displaced by the slide 113 in the tilting direction.

In contrast to the embodiment of the tilting and pivoting lever module 5 according to FIG. 33, in the case of the embodiment according to FIG. 36, intercepting elements for the ends of the levers are no longer required, but rather the two levers 140 and 144 always remain articulated on the casement 2 while, at the same time, the longer lever 140 is permanently articulated on the positionally fixed point of articulation 141 on the frame 1. The two points of articulation 146 and 142 of the levers on the casement 2 can be displaced along the circumference of the casement, the point of articulation 142 along the slot 143 and the point of articulation 146 by means of the movement of the slide.

Furthermore, instead of a hinge on the mounting module 3.4, a ball socket may also be provided between the frame and casement because the casement is pivoted directly out of the release position on the mounting module 3.4, with the mounting module remaining in its position. This ball socket is used at the same time as a tilting axis during tilting of the casement.

1. Window or door construction, comprising
a frame (1),
a casement/leaf (2) attached moveably to the frame,
mounting modules (3.1-3.4, 4.1, 4.2, 5) between the frame and casement/leaf, and
a control element (22) which is guided along the circumference of the casement/leaf (2), is in engagement, in the various positions of the casement/leaf relative to the frame (1), with at least one mounting module and controls the sequence of movement of the mounting modules,
an electric driving motor (60) being fixed on the casement/leaf and driving the control element, which is guided on the casement/leaf, in the circumferential direction in such a manner
that, in a first movement step of the control element in the one or other circumferential direction, the casement/leaf (2) is lifted off essentially parallel from the frame (1) via the mounting modules,
after which a further movement of the control element in the one circumferential direction initiates a tilting of the casement/leaf on the mounting modules,
whereas a further movement of the control element in the other circumferential direction initiates a pivoting of the casement/leaf on at least two mounting modules and the casement/leaf is released from opposite mounting modules to enable it to pivot.

2. Construction according to claim 1, in which mounting modules (3.1 to 3.4) are provided at a distance from one another on the circumference of the casement/leaf (2), each of which has a roller (25) which is displaceable in a horizontal guide (12) of the frame (1), so that the casement/leaf (2) can be moved parallel to the frame (1).

3. Construction according to claim 2, in which the roller (25) of the mounting modules (3.2 and 3.4) fixed at the bottom on both sides of the casement/leaf (2) serves as a joint for a tilting movement of the casement/leaf (2).

4. Construction according to claims 1 to 3, in which a pivoting joint is formed on the mounting modules (3.3, 3.4) arranged on one side of the casement/leaf (2).

5. Construction according to the preceding claims, in which tilting lever modules (4.1, 4.2) are fixed on opposite sides of the casement/leaf (2) and a pivoting lever module (5) is fixed on the upper side of the casement/leaf.

6. Construction according to the preceding claims, in which the control element (22) executes a preliminary control movement (I) in the one or other direction from an initial position (0), which corresponds to the closed position of the casement/leaf (2), the said movement causing all of the mounting modules (3.1-3.4, 4.1, 4.2, 5) to be moved into a predetermined position.

7. Construction according to claim 6, in which the preliminary control movement in the one circumferential direction causes the tilting lever modules (4.1, 4.2) to be connected to the frame (1) whereas the pivoting lever module (5) is fixed to the casement/leaf (2), and the preliminary control movement in the other circumferential direction causes the pivoting lever module (5) to be connected to the frame (1) whereas the tilting lever modules (4.1, 4.2) are fixed to the casement/leaf (2), and in which the preliminary control movement of the control element (22) in the one or other direction causes the mounting modules (3.1-3.4) to be moved out of the locking position.

8. Construction according to the preceding claims, in which the mounting modules (3.1-3.4) have a pivotable retaining element (33) which interacts with two spaced apart retaining pins (11, 11′) on the frame (1) and is in engagement with the control element (22).

9. Construction according to the preceding claims, in which an intercepting element (400) is coupled to the frame end of a tilting or pivoting lever (40; 50), the said intercepting element being controlled by the control element (22) and interacting with a pin (405) fastened to the frame or with a pin (406) fastened to the casement/leaf in order to fix the lever to the frame (1) or to the casement/leaf (2).

10. Construction according to the preceding claims, in which the lower mounting modules (3.2, 3.4) have an arresting device (38) for the roller (25) in the horizontal guide (12) of the frame, and the control element (22) interacts with the tilting lever modules (4.1, 4.2) on both sides of the casement/leaf (2) in such a manner that the control element (22) enters into engagement with the tilting lever modules before the engagement of the control element with the upper mounting modules (3.1 and 3.3) is released.

11. Construction according to the preceding claims, in which a driving module (6) which has an electric driving motor (60) which drives the control element (22) in the circumferential direction is provided on the casement/leaf (2).

12. Construction according to the preceding claims, in which a handle module (7) having a handle (70) is attached to the casement/leaf (2) and can be used to move the control element (22) into a preselection position, and in which the handle (70) has a release button (71) which can be used to release the control element (22) from the driving module (6).

13. Method for actuating a window or door construction having a frame (1), a casement/leaf (2) attached moveably to the frame, mounting modules (3.1-3.4, 4.1, 4.2, 5) between the frame and casement/leaf, and an encircling control element (22) which controls the sequence of movement at least of some of the mounting modules, the control element (22) being moved from an initial position (0) in the one circumferential direction in order to control the tilting of the casement/leaf, and being moved from the initial position (0) into the other circumferential direction in order to control the pivoting of the casement/leaf, the sequential succession of control movements of the control element in the one or other circumferential direction clearly defining the respective positions of the casement/leaf relative to the frame.

14. Method according to claim 13, in which prior to a tilting or pivoting movement of the casement/leaf, the latter is lifted off parallel from the frame (1) and a tilting or pivoting movement is carried out only from a position of the casement/leaf in which it has been lifted off parallel, and in which prior to the casement/leaf (2) being lifted off parallel from the frame (1), a preliminary control movement is executed in the one or other circumferential direction and is used to define a preselection for tilting or pivoting the casement/leaf, and a transfer from pivoting to tilting and vice versa is only possible by the casement/leaf being returned into the closed position, from which the preselection in the tilting or pivoting direction takes place.

15. Method according to claims 13 and 14, in which a motor (6) driving the control element (22) is released from engagement with the control element when the casement/leaf is brought manually by means of a handle (70) into an opened or closed position, the movements of the casement/leaf which are executed manually being used to move the control element, by virtue of it being coupled to the mounting modules, into the control position which corresponds to the particular casement/leaf position.

16. Window or door construction, comprising
a frame (1),
a casement/leaf (2) attached moveably to the frame,
mounting modules (3.1-3.4, 5) between the frame and casement/leaf, and
a control element (22) which is guided along the circumference of the casement/leaf, is in engagement, in the various positions of the casement/leaf relative to the frame, with at least one mounting module and controls the sequence of movement of the mounting modules, an electric driving motor (60) being fixed on the casement/leaf and adjusting a slide (113), which is guided on the casement/leaf (2), in the circumferential direction,
the slide (113) being connected to the control element (22) via a releasably coupling mechanism (125) in such a manner that, when a tilting or pivoting movement of the casement/leaf is initiated, the slide (113) is released from the control element (22) and the slide (113), which is driven by the driving motor, controls the tilting or pivoting movement via a lever (111, 112; 140) which is coupled to the slide (113) and to the frame (1).

17. Construction according to claim 16, in which retaining pins (101) protrude on the circumference of the frame (1) and engage in a horizontal guide (107) on the mounting modules (3.1 to 3.4) and in a control groove (106) of a control slide (102), which can be displaced in the mounting module and is in engagement with the control element (22) which can be displaced on the circumference of the casement/leaf (2).

18. Construction according to claim 17, in which a roller (101.1) for engagement in the horizontal guide (107) and a roller (101.2) for engagement of the retaining pin in the control groove (106) is provided on the retaining pin (101) and has a smaller diameter than the roller (101.1) provided for load-carrying in the horizontal guide.

19. Construction according to claims 17 and 18, in which the control slide (102) is guided in a housing-shaped mounting part (105) by means of longitudinal guides (103, 104).

20. Construction according to claims 16 to 19, in which the one part of a hinge (109) is fastened to the mounting modules (3.3 and 3.4), which are provided for pivoting the casement/leaf, and the other part of the hinge is fastened to the casement/leaf (2), so that the mounting module can remain on the frame (1) during pivoting of the casement/leaf (2).

21. Construction according to claim 16, in which a tilting lever (112) and a pivoting lever (111) are coupled to the slide (113) and their opposite ends can be introduced into intercepting elements (114, 115) on the frame (1) during the adjusting movement of the slide in order to control the tilting and pivoting movement of the casement/leaf (2).

22. Construction according to claim 21, in which the slide (113) is connected to the control element (22) when being lifted parallel out of the locking position and, when the tilting or pivoting movement of the casement/leaf (2) is initiated, is released by the coupling mechanism from the control element (22) while at the same time the control element (22) is fixed in its position on the casement/leaf (2) by a latching device (128, 130).

23. Construction according to claim 16, in which a control lever (144) is coupled to the slide (113) and is connected in an articulated manner to a linking lever (140), one end of which is coupled to the frame (1) while the opposite end is guided in an articulated manner in the circumferential direction of the casement/leaf in a longitudinal guide (143) of the casement/leaf (2).
